(19) United States
(12) Patent Application Publication
(10) Pub. No.: US 2006/0002246 A1
(43) Pub. Date: Jan. 5, 2006

(54) Sector-based worm implementation on random access memory

(75) Inventors: Robert George Emberty, Tucson, AZ (US); Nils Haustein, Zornheim (DE); Craig Anthony Klein, Tucson, AZ (US); Daniel James Winarski, Tucson, AZ (US)

Correspondence Address: William D. Gill;IBM Corporation, 5600 Cottle Road (L2PA/010), San Jose, CA, 95193, US

(73) Assignee: International Business Machines Corporation, Armonk, NY (US)

(21) Appl. No.: 10/882,890

(22) Filed: Jun. 30, 2004

(51) Int. Cl. G11B 21/08

(52) U.S. Cl. 369/30.03; 369/47.1

(57) ABSTRACT

A disk drive data storage device and a method for implementing a sector selectable write-once read-many (WORM) functionality on the disk drive storage system are disclosed. Data stored in a sector on magnetic storage media or on rewritable optical media are protected from being overwritten by having additional (WORM) bits in the sector header to denote the protection status of the data in that sector. When data is to be written to a sector of a disk drive of the storage system, the sector header for that sector is read and the WORM bits are examined. If the value of the WORM bits indicates that the sector is protected, the write command will not be executed and an appropriate error condition is posted to the host system. If the WORM bits for the sector indicates no WORM protection, the data is written to the sector.

### TECHNICAL FIELD

This invention relates to data recording information storage systems and methods related thereto. In particular, the invention relates to data recording disk drives and host computers having means for selectively and permanently disabling overwrite modes of the disk drives when the data written to these disk drives needs to be write-once, read-many (WORM).

### BACKGROUND

Information storage devices, which include magnetic storage devices and optical data storage systems, utilize at least one rotatable disk with concentric data tracks containing the information, a transducer for reading data from or writing data to the various tracks, and a head positioning actuator connected to a head from moving it the desired track and maintaining it over the track during read or write operations. The I/O transducer is attached to a suspension, and that suspension is attached to an actuator arm of the head positioning actuator. There are typically a plurality of disks separated by spacer rings, the spacer rings allowing heads to access the disks. The disks are stacked on a hub that is rotated by a spindle motor. A housing supports the spindle motor and head actuator and also surrounds the head and disk(s) to provide a substantially environmentally sealed container for the head-disk interface.

Generally a data processing system operates with a host processor including a main memory, typically comprising solid state memory, and a secondary memory comprising one or more storage devices such as a magnetic disk or optical disk storage device. Magnetic disk storage devices typically have a read/write capability, allowing the magnetic disk to be written and read many times. Most optical data storage systems utilize optical media, including disks recorded using rewritable and Write-Once Read-Many (WORM) techniques. Optical disks recorded according to WORM techniques, are often used for archival purposes because they can be written only once by a laser. These WORM techniques include irreversible surface ablation and irreversibly combining two metal films into an alloy of different reflectivity. These optical WORM techniques do not exist for magnetic disk storage devices.

Another optical WORM recording technique is called Continuous Composite WORM (CCW), which includes an optical media which is rewritable. The WORM protection is simulated through the optical disk drive microcode. The optical media format logically indicates that it is a WORM media, even though the media is physically rewritable. The optical disk drive accepts this logical format indication of WORM, and only allows writing each data area only once. The problem with this CCW format is that a drive with altered microcode could easily ignore the logical WORM format indicator and freely rewrite the media. This rewritten media would appear as WORM when placed in a drive without altered microcode, and thus present data integrity issues.

There are some applications in which it is necessary or highly advantageous to provide a permanent, non-alterable version of a file. For example, legal documents, such as Securities and Exchange Commission (SEC) records, stock trading records, business dealings, e-mail, insurance records, etc. should be permanently stored on a media that cannot be altered once the files have been written to the storage device. Similar requirements for permanence exist for medical records and images. Traditionally, WORM functionality has been provided by ablative or alloy optical media used in optical disk drives.

Given the ease with which data can be altered on conventional magnetic storage media, a number of applications use optical disks for providing such “permanent” or “non-alterable” storage. However, there is a need to provide such WORM functionality in a magnetic storage device, such as a hard disk drive (HDD) or a direct access storage device (DASD). One method of providing such functionality is to permit a manual change to the HDD such as setting an external switch or a jumper (pin or wire) to a write-inhibit position to prevent the magnetic storage media from being overwritten. This method suffers from the drawback that the mechanism is easily reversed to make the media writable once again, because the switch or jumper could be temporarily reset to permit alteration of the data, and then reset back to the write-inhibit position. Such a solution is unsatisfactory for the typical WORM applications, which require the integrity of the saved data be maintained, where a true WORM function is required. Therefore, a need exists for secure WORM functionality in a magnetic hard disk drive.

### SUMMARY OF THE INVENTION

In accordance with the principles of the present invention, there is disclosed a data disk storage system wherein data stored in a sector on magnetic storage media or on rewritable optical media are protected from being overwritten by having additional (WORM) bits in the sector header to denote the protection status of the data in that sector. The sector header is meta data containing information about the sector which usually precedes the actual data in a sector. When data is to be written to a sector of a disk drive of the storage system, the sector header for that sector is read and the WORM bits are examined. If the value of the WORM bits indicates that the sector is protected, the write command will not be executed and an appropriate error condition is posted to the host system. If the WORM bits for the sector indicates no WORM protection, the data is written to the sector.

In one embodiment of the invention, once data is written to a sector the WORM bits stored in the sector header are set to a value indicating WORM protection for the sector. Subsequent attempts to write data to this sector will not be honored. In this embodiment, the WORM protection is automatically set for all written sectors without the user having a choice. In another embodiment of the invention, the setting of the WORM bits to give WORM protection is selectively set for a particular sector by utilizing an appropriate I/O command.

An important and novel feature of the invention is that the WORM protection status of the WORM bits cannot be reset in the sector header. The inability to reset the WORM protection status ensures true WORM protection of the data in the protected sectors.

The sector-based WORM protection of the invention may be applied to magnetic storage systems using magnetic storage media and to systems using rewritable optical media. Rewritable optical disks typically use embossed sector headers. These optical sector headers may be modified to include a phase change region for storing the WORM protection status of the sector, allowing the sector-based WORM protection to be used with digital video disk-recordable (DVD-R), digital video disk-read/write (DVD-RW), digital video disk-RAM (DVD-RAM) and all other writable optical disk memory systems.

For a fuller understanding of the nature and advantages of the present invention, reference should be made to the following detailed description taken together with the accompanying drawings.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 shows a side view of a hard disk drive;

FIG. 2 shows a top view of a hard disk drive;

FIG. 3 shows the control circuitry of a hard disk drive;

FIG. 4 shows a computer system utilizing a hard disk drive;

FIG. 5 shows a typical format of a disk surface;

FIG. 6 shows a sector header for a sector on a disk surface;

FIG. 7 shows allowable transitions of the WORM protection status;

FIG. 8 shows an exemplary SCSI write command;

FIG. 9 shows a flowchart for the write command processing direct writing of WORM data;

FIG. 10 shows an exemplary SCSI read LONG command;

FIG. 11 shows a sector format layout for a magneto optical disk cartridge;

FIG. 12 shows the format of the WORM protection status in the data field for a magneto optical cartridge;

FIG. 13 shows the sector format layout for a DVD-RAM disk;

FIG. 14 shows an exemplary SCSI write verify command;

FIG. 15 shows a schematic view of prior art Sector Servo Sector Format, used by many disk drive manufacturers prior to 1995;

FIG. 16 shows the Sector Servo Sector format with embedded flags in the ID region;

FIG. 17 shows the flow chart of how a write process is handled in the Sector Servo Sector format with embedded flags in the ID region;

FIG. 18 shows the Sector Servo Sector format with embedded WORM flags in the Data region;

FIG. 19 shows a flow diagram of the process used to write a sector of the Sector Servo Sector format with embedded WORM flags in the Data region;

FIG. 20 shows a schematic view of prior art Dedicated Servo Sector format;

FIG. 21 illustrates the Dedicated Servo Sector format with the previously defined WORM flags embedded in the ID and Recovery region;

FIG. 22 shows a flow chart of the process of handling a command in a Dedicated Servo Sector format with the WORM flags embedded in the ID and Recovery region;

FIG. 23 illustrates the Dedicated Servo Sector format with the previously defined WORM flags embedded in the Data region;

FIG. 24 shows the process of handling a command with the Dedicated Servo Sector format with the WORM flags embedded in the Data region;

FIG. 25 shows a schematic view of prior art No-ID Sector Servo Sector format;

FIG. 26 shows a schematic view of the No-ID Sector Servo Sector format with the previously defined WORM flags embedded in the Servo and Recovery region;

FIG. 27 shows a flow diagram of the processing of commands with the No-ID Sector Servo Sector format with the WORM flags embedded in the Servo and Recovery region;

FIG. 28 shows a schematic view of the No-ID Sector Servo Sector format with the previously defined WORM flags embedded in the Data region;

FIG. 29 diagrams the processing of commands for the No-ID Sector Servo Sector format with the WORM flags embedded in the Data region;

FIG. 30 shows a schematic view of prior art No-ID Dedicated Servo Sector format;

FIG. 31 shows a schematic view of the No-ID Dedicated Servo Sector format with the previously defined WORM flags embedded in the Track ID and Recovery region;

FIG. 32 details the process flow for command processing to a disk with the No-ID Dedicated Servo Sector format with the WORM flags embedded in the Track ID and Recovery region;

FIG. 33 shows a schematic view of the No-ID Dedicated Servo Sector format with the previously defined WORM flags embedded in the Data region; and

FIG. 34 charts the flow of the command processing for a disk with the No-ID Dedicated Servo Sector format with the WORM flags embedded in the Data region.

### DETAILED DESCRIPTION OF THE PREFERRED EMBODIMENT

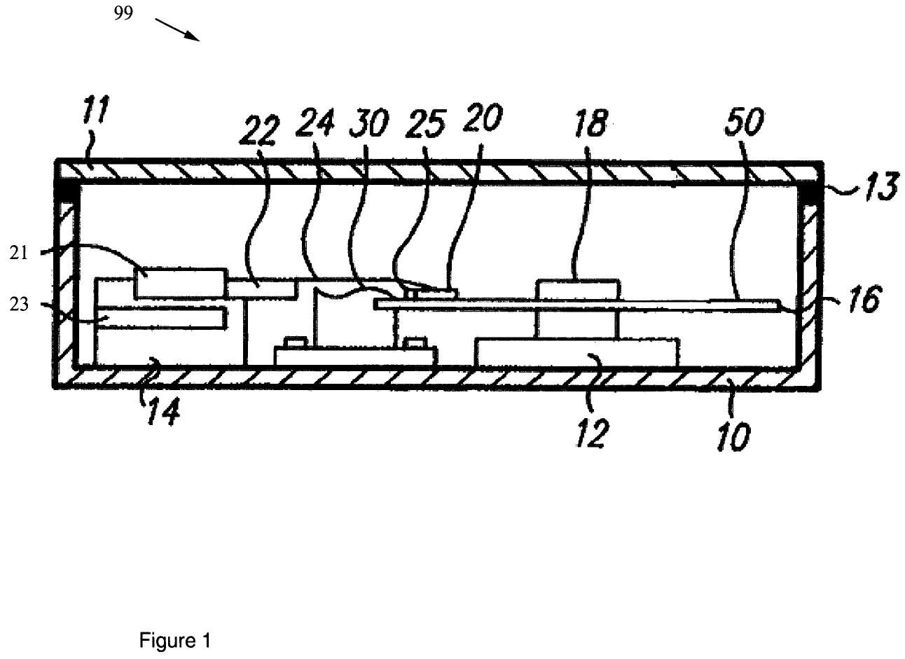

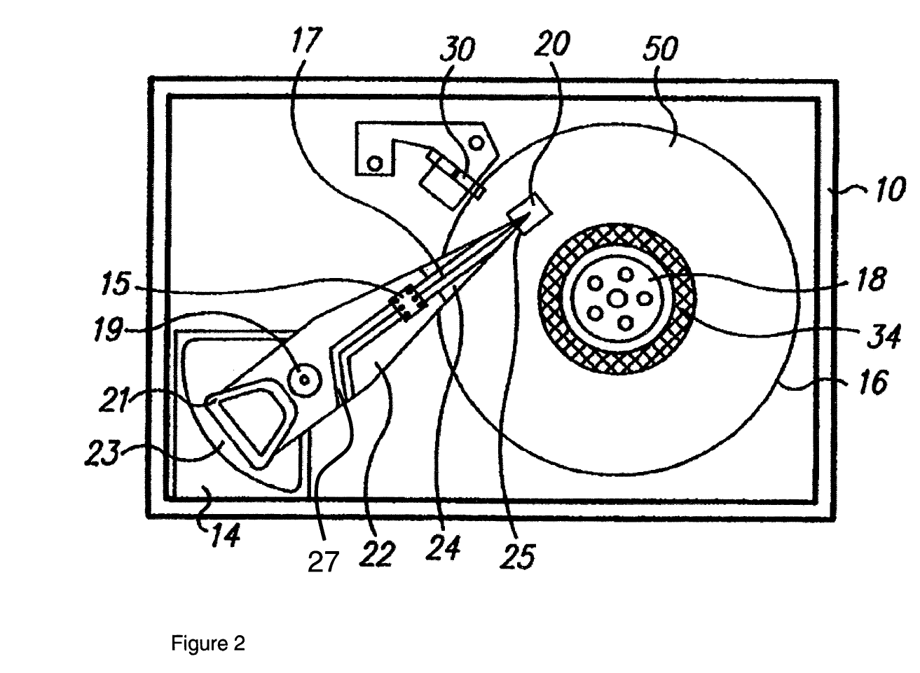

Referring first to FIG. 1, there is illustrated in sectional view a schematic of a hard disk drive (HDD) 99 using the present invention. For ease of illustration and explanation, the disk drive 99 depicted in FIGS. 1 and 2 is shown as having a single recording head and associated disk surface, although conventional disk drives typically have multiple heads, one on each side of multiple disks and the present invention applies equally to both multiple disk/head and single disk/head drives.

The disk drive 99 comprises a base 10 to which are secured a spindle motor 12, an actuator 14 and a cover 11. The base 10 and cover 11 provide a substantially sealed housing for disk drive 99. Typically, there is a gasket 13 located between base 10 and cover 11. A small breather port (not shown) for equalizing the air pressure between the interior of disk drive 99 and the outside environment is typically placed in a base 10 of larger HDDs. Smaller HDDs, such as the HDDs used in laptops and notebooks, may not need this small breather port due to the tiny amount of free cavity volume in smaller HDDs. This type of disk drive is described as being substantially sealed because the spindle motor 12 is located entirely within the housing and there is no external forced air supply for cooling the interior components. A magnetic recording disk 16 is connected to spindle motor 12 by means of spindle or hub 18 for rotation by spindle motor 12. A thin film 50 of lubricant is maintained on the surface of disk 16. The lubricant may be a conventional perfluoro-polyether (PFPE) disk lubricant, such as Demnum SP brand manufactured by Daikin or Z-DOL brand manufactured by Montedison.

A read/write head or transducer 25 is formed on the trailing end of an air-bearing slider 20. Transducer 25 typically has an inductive write transducer and either a magnetoresistive (MR) or a giant magnetoresistive (GMR) read transducer, all of which are formed by thin-film deposition techniques as is known in the art. The slider 20 is connected to the actuator 14 by means of a rigid arm 22 and a flexible suspension 24, the flexible suspension 24 providing a biasing force which urges the slider 20 towards the surface of the recording disk 16. The arm 22, flexible suspension 24, and slider 20 with transducer 25 are referred to as the head-slider-arm (HSA) assembly.

During operation of disk drive 99, the spindle motor 12 typically rotates the disk 16 at a constant angular velocity (CAV), and the actuator 14 pivots on shaft 19 to move slider 20 in a gentle arc that is aligned generally radially across the surface of disk 16, so that the read/write transducer 25 may access different data tracks on disk 16. The actuator 14 is typically a rotary voice coil motor (VCM) having a coil 21 that moves in an arc through the fixed magnetic field of magnet assembly 23 when current is applied to coil 21. Alternately, arm 22, flexible suspension 24, slider 20, and transducer 25 could move along a radial line via a linear VCM (not shown).

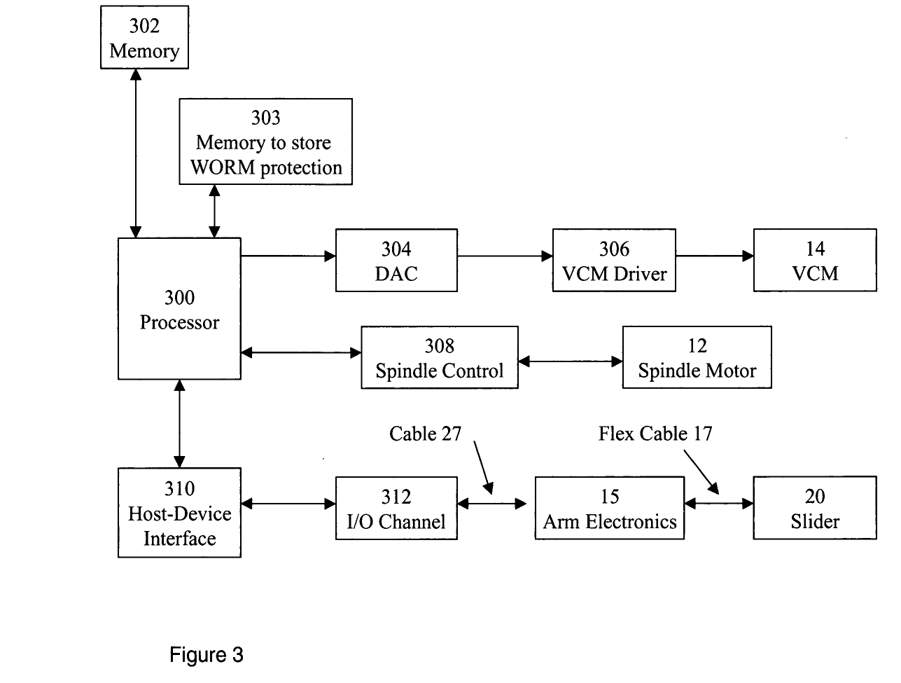

FIG. 2 is a top view of the interior of disk drive 99 with the cover 11 removed, and illustrates in better detail flexible suspension 24 which provides a force to the slider 20 to urge it toward the disk 16. The suspension may be a conventional type of suspension such as the well-known Watrous suspension, as described in U.S. Pat. No. 4,167,765. This type of suspension also provides a gimbaled attachment of the slider 20 that allows the slider 20 to pitch and roll as it rides on the air bearing. The data detected from disk 16 by transducer 25 is processed into a data readback signal by an integrated circuit signal amplification and processing circuit in arm electronics (AE) 15, located on arm 22. The signals between transducer 25 and arm electronics 15 travel via flex cable 17. The signals between arm electronics 15 and I/O channel 312 of FIG. 3 travel via cable 27. Arm 22 rotates about pivot 19.

In the load/unload embodiment of disk drive 99, a load/unload ramp 30 is mounted to the base 10. Ramp 30 contacts suspension 24 and lifts the slider 20 away from disk 16 when the actuator 14 rotates the slider 20 toward the disk outside diameter when disk drive 99 is powered down. Such powering down can include a power-saving sleep mode when disk drive 99 has been inactive for a predetermined period of time. If disk drive 99 does not utilize a load/unload ramp 30, disk 16 typically has a dedicated textured landing zone 34 near the inside diameter of disk 16, away from the data region. Disk drive 99 moves slider 20 to textured landing zone 34 when disk drive 99 is powered down. Disk drive 99 may have both a load/unload ramp 30 and a textured landing zone 34.

In general, the preferred parking location for the actuator 14 when disk drive 99 is stopped will be its usual storage location, i.e., either with the slider 20 unloaded off the disk 16 onto load/unload ramp 30 (for a load/unload drive) or with the slider 20 in contact with the textured surface of disk 16 at landing zone 34 (for a non-load/unload drive). At these locations, the slider 20 is not in contact with the smooth data region of the disk and a powered-off disk drive can be started using normal startup procedures of high current supplied to spindle motor 12 until disk 16 accelerates to its operating RPM.

Referring now to FIG. 3, drive electrical components include a processor 300 that processes instructions contained in memory 302. Processor 300 may comprise an off-the-shelf processor, custom processor, FPGA (Field Programmable Gate Array), ASIC (Application Specific Integrated Circuit), discrete logic, etc. Memory 302 is used to hold variable data, stack data, and executable instructions. Memory 302 is preferably RAM (Random Access Memory). Processor 300 also accesses a second memory 303, wherein the WORM protection status for each sector is stored. The memory 303 is preferably FLASH memory, however, memory 303 may comprise PROM (Programmable Read-Only Memory) or EPROM memory (Erasable Programmable Read-Only Memory). Processor 300 sends digital signals to digital-to-analog converter (DAC) 304, for conversion to low-power analog signals. These low-power analog signals are received by VCM driver 306. VCM driver 306 amplifies the low-power analog signals into high-power signals to drive VCM 14. Processor 300 also controls and is connected to the spindle motor 12 via spindle controller 308. VCM 14 is energized by the VCM driver 306 which receives analog voltage signals from DAC 304. VCM driver 306 delivers current to the coil of VCM 14 in one direction to pivot the head-slider-arm assembly radially outward and in the opposite direction to pivot the head-slider-arm assembly radially inward. The spindle controller 308 controls the current to the armatures of spindle motor 12 to rotate the motor at a constant rotational speed, which is also known as constant angular velocity or CAV, during drive operation. In addition, the spindle controller 308 provides a status signal to processor 300 indicating whether or not spindle motor 12 is rotating at its operating speed via the back electromotive force (BEMF) voltage from spindle motor 12, which will have a non zero value when motor 12 is rotating. Spindle motor 12 is commonly a brushless DC motor with three windings or three sets of windings. Spindle motor 12 typically has ball bearings for low rotational speed drives (less than 10000 RPM (revolutions per minute)). For high speed disk drives (10000 to 15000 RPM), fluid bearings may be used.

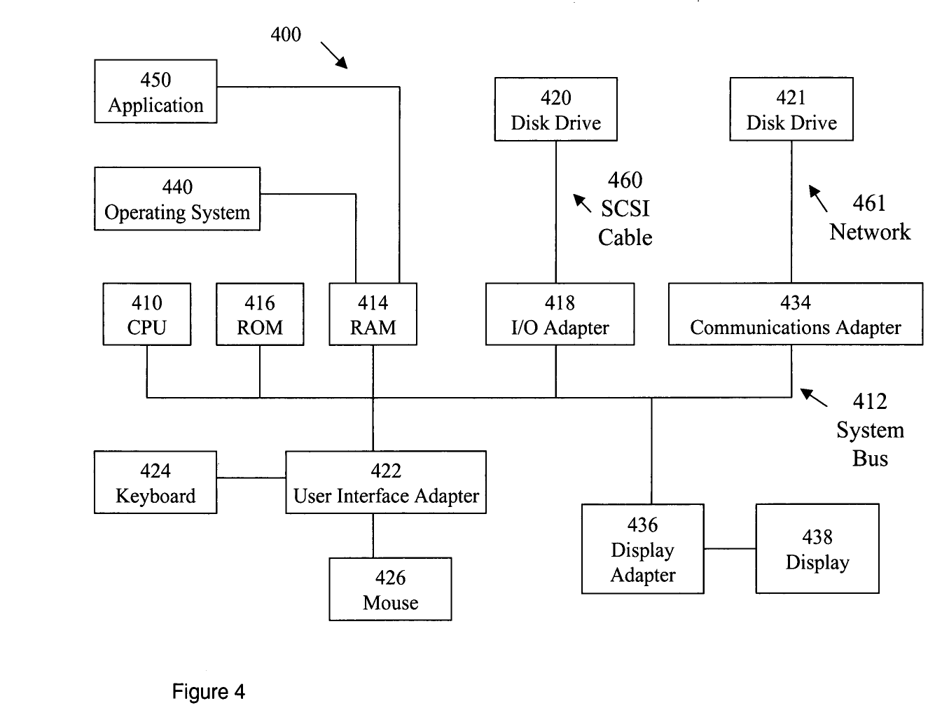

Host-device interface 310 communicates with processor 300. Additionally, host-device interface 310 receives data from host computer 400 (FIG. 4) and sends it to I/O channel 312, where the data is encoded before being sent via cable 27 to arm electronics 15. Typical encoding is via a convolution encoder. From arm electronics 15, the encoded data is sent via flex cable 17 to the inductive write transducer on slider 20 resulting in the encoded data being written to disk 16. Similarly, when data is requested by host computer 400, the MR or GMR read transducer on slider 20 reads the encoded data off of disk 16, and sends that data to arm electronics 15 via flex cable 17. From arm electronics 15, the encoded data is sent via cable 27 to be decoded by I/O channel 312 before being sent to host computer 400 via host-device interface 310. A typical decoder is a PRML (partial-response, maximum likelihood) decoder.

FIG. 4 illustrates a typical hardware configuration of a host computer 400 utilizing the hard disk drive shown in FIGS. 1 and 2. Host computer 400 has a central processing unit (CPU) 410 coupled to various other components by system bus 412. An operating system 440, runs on CPU 410 and provides control of host computer 400 and the attached disk drives 420 and 421, either of which may incorporate hard disk drive 99. Alternately, disk drives 420 or 421 could be optical disk drives. Keyboard 424 and mouse 426 are connected to system bus 412 via user interface adapter 422.

Read only memory (ROM) 416 is coupled to system bus 412 and includes a basic input/output system (BIOS) that controls certain functions of computer 400. Random access memory (RAM) 414, I/O adapter 418, and communications adapter 434 are also coupled to system bus 412. It should be noted that software components including operating system 440 and application 450 are loaded into RAM 414, which is the main memory of computer 400. I/O adapter 418 may be a small computer system interface (SCSI) adapter. SCSI cable 460 is connected between I/O Adapter 418 and Host-Device Interface 310 of FIG. 3 so that host computer 400 communicates with disk drive 420. Similarly, communications adapter 434 communicates with Network Attached Storage (NAS) disk drive 421 via network 461. Communications adapter 434 may be an Ethernet, Fiber Channel, ESCON, FICON, Wide Area Network (WAN), or TCP/IP interface. A display monitor 438 is connected to system bus 412 by display adapter 436. In this manner, a user is capable of receiving visual messages concerning the disablement of the write-mode.

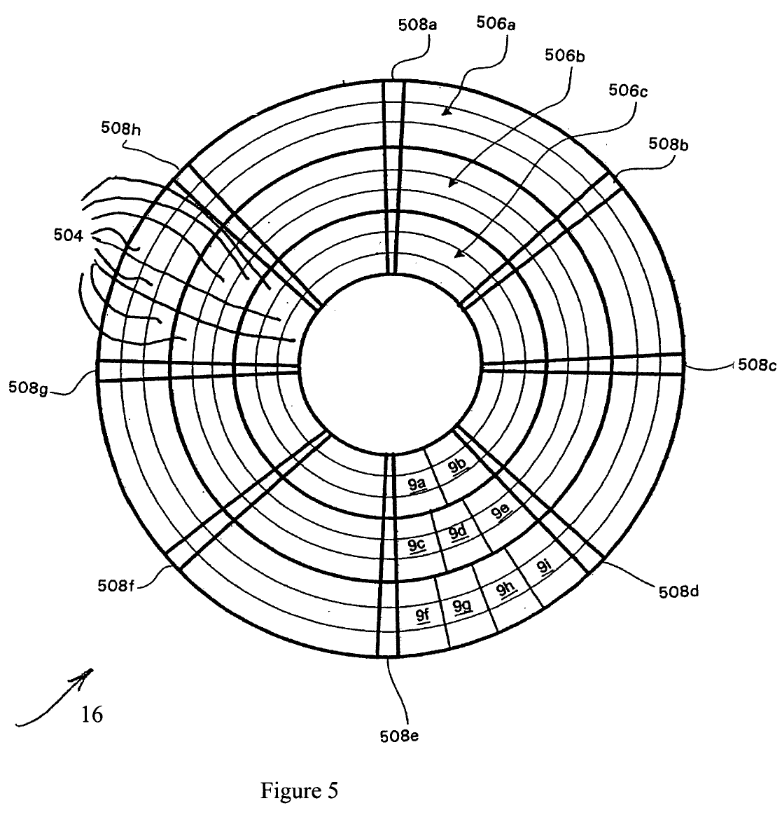

FIG. 5 illustrates an arrangement of a recording surface of disk 16 divided into concentric circular “tracks” on the disk surface. Disk 16 rotates at a constant angular velocity (CAV). It is divided up into zones 506a, 506b, and 506c, so the overall format of disk 16 is ZCAV, or zoned constant angular velocity. Each zone is divided into data sectors laid out on concentric tracks 504. Alternately, spiral tracks may be used. In a given angular region, outer zone 506a has data sectors 9f, 9g, 9h, and 9i; middle zone 506b has data sectors 9c, 9d, and 9e; and inner zone 506c has data sectors 9a and 9b. A logical block address (LBA) is used to address a specific data sector 9a-9i. A data sector is the smallest logical unit that can be accessed on the disk. The size of a hard disk data sector 9a-9i is typically 512 bytes, but the size of an optical disk data sector (not shown) is typically 2048 or 4096 bytes. As can be seen in FIG. 5, there are more data sectors per track in the outer zones than in the inner zones.

Prerecorded servo sectors 508a-508h are also shown. The servo sectors 508a-508h are contiguous from the inner to the outer data radius of the disk. The servo sectors are radial if the head moves linearly across the disk. The servo sectors will gently arc if the arm 22 rotates about a pivot 19, as shown in FIG. 2. The servo sectors may actually cut across data sectors 9a-9f, which is called split-sectoring, although that is not shown in FIG. 5. The servo sectors may include servo identification (SID) information and a quadrature ABCD burst. The quadrature ABCD bursts in each servo sector are read by the magnetic head and used to keep the head over the proper data track 504.

Typically, the data on magnetic storage media is stored in sectors. Each sector is addressed with a Logical Block Address (LBA). Each sector contains meta data in addition to the user data. The sector meta data contains descriptors for the data area including a unique sector number and synchronization marks. The meta data may be stored in a sector header area or, alternatively, in the same area as the user data. In this invention, the area where the meta data is stored is referred to as the sector header. Therefore, the sector header does not need to be a preceding header, but can be some other field in the sector. Each sector has a unique logical number which represents the cylinder and track. In this embodiment, this logical number is also represented as a physical number in the sector header. Before a HDD writes data to a sector, it reads the header to identify the correct position on the disk based on the sector number or LBA.

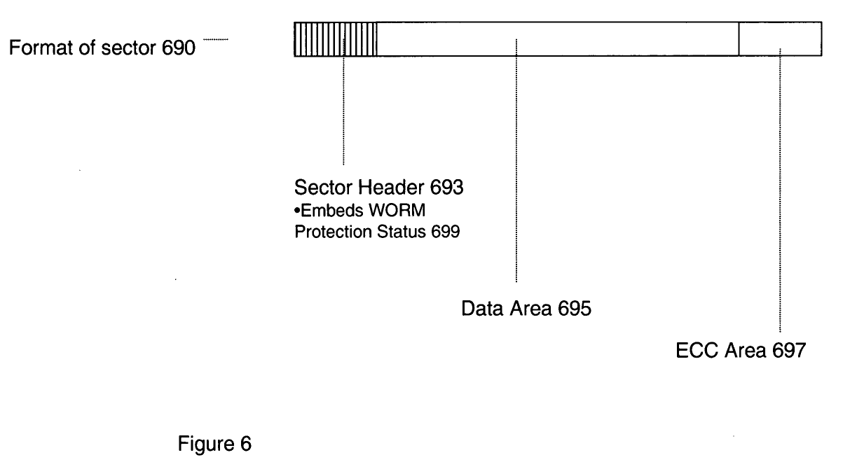

FIG. 6 shows an exemplary sector 690 on a storage media. In a fixed block architecture, the sector 690 has a fixed size which is manufacturer dependent. The sector comprises a sector header 693, a data area 695 (usually 512 bytes for hard disk sectors and 2048 or 4096 bytes for optical disk sectors), and an error correction code (ECC) area 697. The header 693 contains meta data for the sector including the address of the sector, the head and the cylinder. The sector header 693 is followed by the data area 695 with a fixed size followed by the ECC area 697. The ECC area contains error correction code which allows reconstruction of partially lost data from the data field 695. In the present embodiment, two bits of data information denoting WORM protection status 699 of the sector are embedded in the sector header 693. Alternatively, the WORM protection status can be stored in another area of the sector which is not accessible from the host system. The WORM protection status can be included with the ECC area 697. For example, IBM patent U.S. Pat. No. 6,079,044 by Cunningham teaches encoding the sector number with the ECC when No-ID is used. This allows verifying the sector number even though there is no sector ID. Therefore, it is possible to also include the WORM protection status with the ECC.

The format of the sectors on a storage medium is usually established during manufacturing or subsequent formatting operations. According to the invention, during manufacturing of the disk drive, a WORM protection status 699 is written to the sector header 693 indicating that the sector is in an initialized state. The storage I/O device reads the sector header information every time an operation requires access to the data area 695. At this time, the storage device can read the WORM protection status of the sector and derive subsequent actions. On a subsequent write operation that is granted the WORM protection status 699 in the sector 693 will be changed to reflect WORM protection.

Using the two bits in the sector header 693, the WORM protection status is encoded with the following meanings: a value of 0 means that the sector is initialized, but no data has been written (set during the manufacturing process only); a value of 1 means that the sector is rewritable; a value of 2 means that the sector is WORM protected and the sector cannot be written again; and a value of 3 is reserved for future use. An aspect of this invention is that once a value of 2 is set (WORM protection), it cannot be reset. This is realized in the control logic of that storage device. In other words, the control logic implements a method which does not allow to reset a value of 2 (WORM protection) in the sector header, simply by not allowing that operation in the microcode for sectors already demarked as WORM. Implementation of this feature ensures true WORM protection of the data in the protected sector. In disk drive systems having self-servo write, the hard disk drive can write its own servo sectors and its own sector headers. The implementation of FIG. 6 is that the target LBAs are first read to see if there is a value of 2 (WORM protection), as no further writing is done if the data is already WORM. However, if the data is to be WORM and is not currently WORM, the data and servo sectors are rewritten to the disk with servo sectors having a WORM protection value of 2.

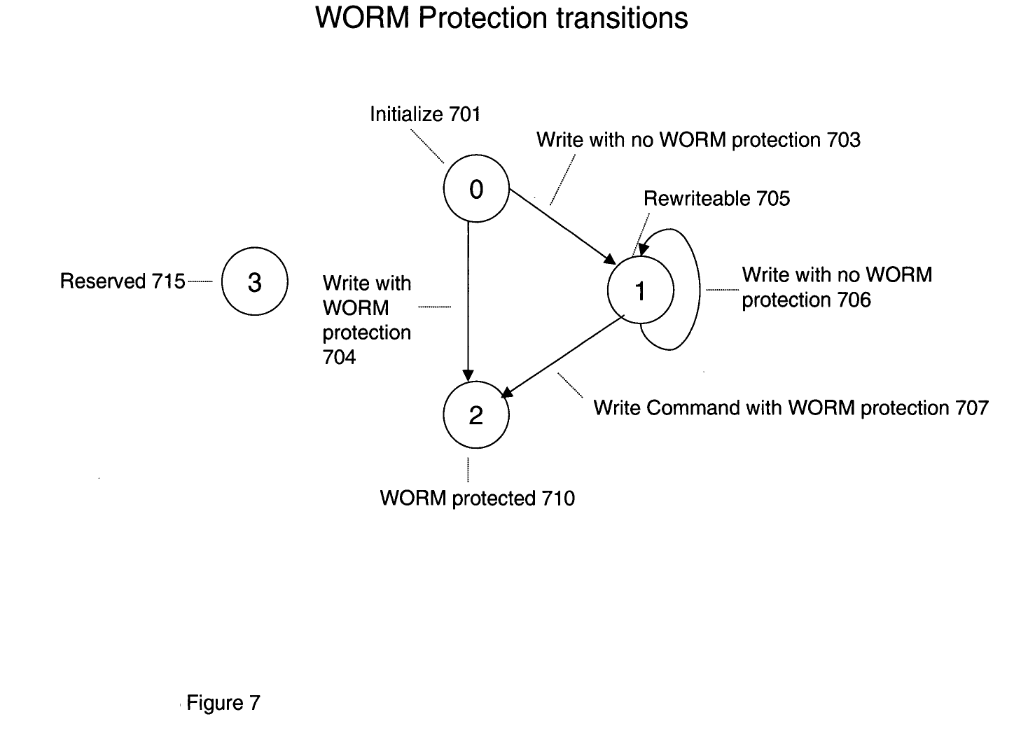

FIG. 7 is a diagram showing the allowable transitions for the WORM protection status of a particular sector. Only during initialization in the manufacturing process of the HDD, the initialized status 701 is set to value 0. Thus state 701 is the initial state for all the data sectors of the HDD. The initialized status 701 can be changed to either rewritable status 705 having a value 1 or to WORM protected status 710 having a value 2. The decision to set WORM protection on or not is implemented by the write command as described hereinafter. If the write command indicates write with no WORM protection 703, the status will be changed to rewritable 705 having a value 1. If the write command indicates write with WORM protection 704, the status will be changed to WORM protected 710 having a value 2. The rewritable status 705 is maintained (rewrite with no WORM protection 706) as long as subsequent write commands do not indicate WORM protection. The rewritable status 705 is set to WORM protected 710 when a subsequent write command indicates write with WORM protection 707. Once the status is set to WORM protected 710 having a value 2, the value cannot be reset.

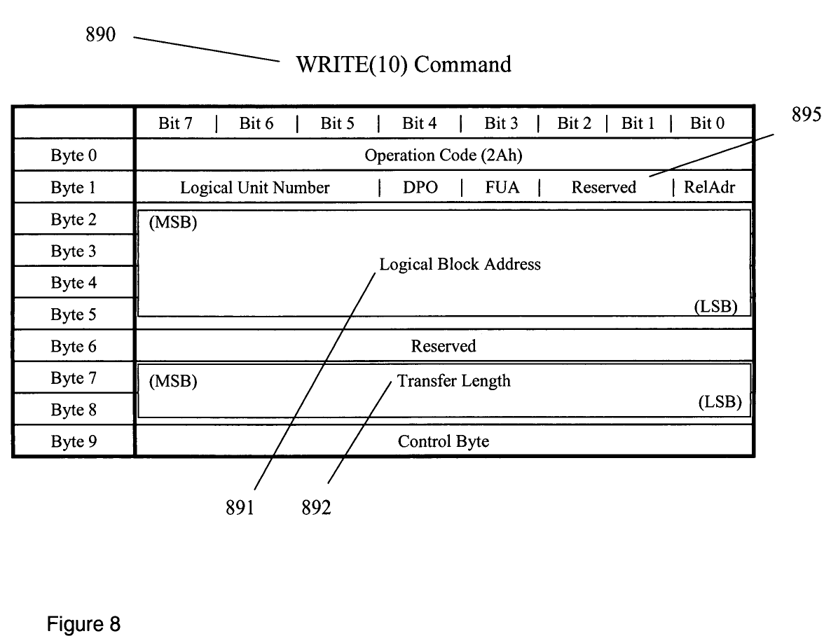

A read or a write command, such as a SCSI WRITE(10) command 890 shown in FIG. 8, includes a starting LBA address 891 of the command and a transfer or transaction length 892. For FBA (fixed block length) addressing, transaction length 892 is in multiples of the fixed block length, which is identical to an incremental LBA transfer length. Thus, the last LBA written is the sum of the starting LBA address 891 and the incremental LBA transaction length 892. The processor 300 maps the LBA to a specific data position on one of the disk surfaces, which is called a physical sector. In this embodiment, the LBA's are preferably mapped in tracks, shown in FIG. 5, and cylinders. Cylinders are logically formed from similar tracks on each data surface in hard disk drive 99, to enable data to be written on the similar tracks of different disk surfaces via head switching rather than seeking, as head switching is often faster than seeking. The read or write command 890 includes a reserved area 895. Bit 1 of byte 1 in the reserved area 895 of the write command is used to designate the WORM protection status of the data to be written in the sectors designated by the starting LBA address 891 and transfer length 892.

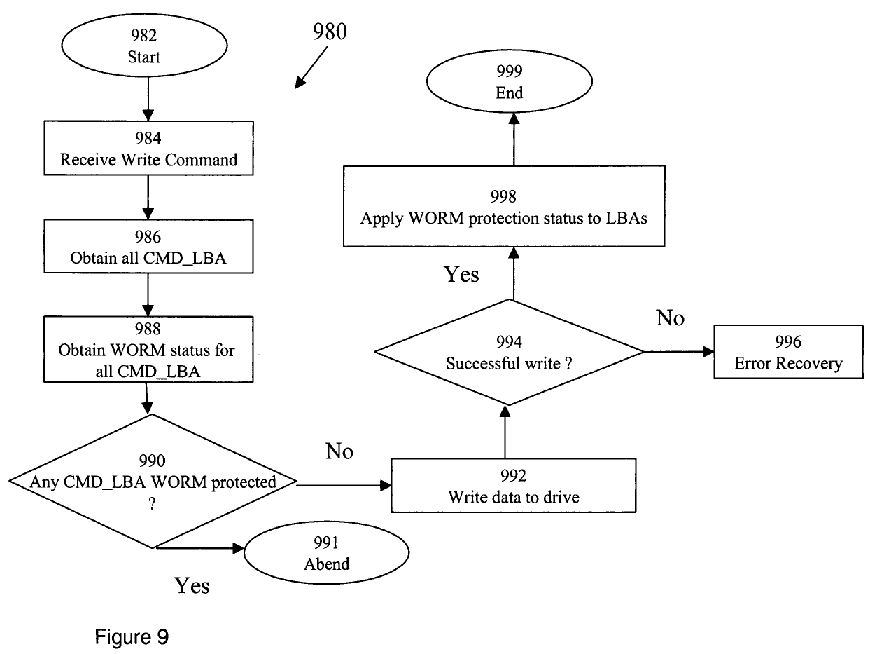

FIG. 9 is a flow chart of the write command process using the WORM protection status 895 in the write command 890 for direct writing of WORM data to the disk 16. The algorithm 980 begins with a start step 982 which flows sequentially to a receive write command step 984 at which the WORM write command is received, a obtain all CMD_LBA step 986 at which all the CMD_LBA are received from the write command, and an obtain WORM status for all CMD_LBA step 988. The CMD_LBA are all the logical block addresses from the starting LBA 891 in the WRITE(10) command 890 of FIG. 8 to the LBA obtained by adding the transfer length 892. In the preferred embodiment, the WORM protection status for all the LBAs is stored in an extra memory 303 of the storage device. This increases the write performance because the identification of WORM protection status does not require physical access to the storage medium.

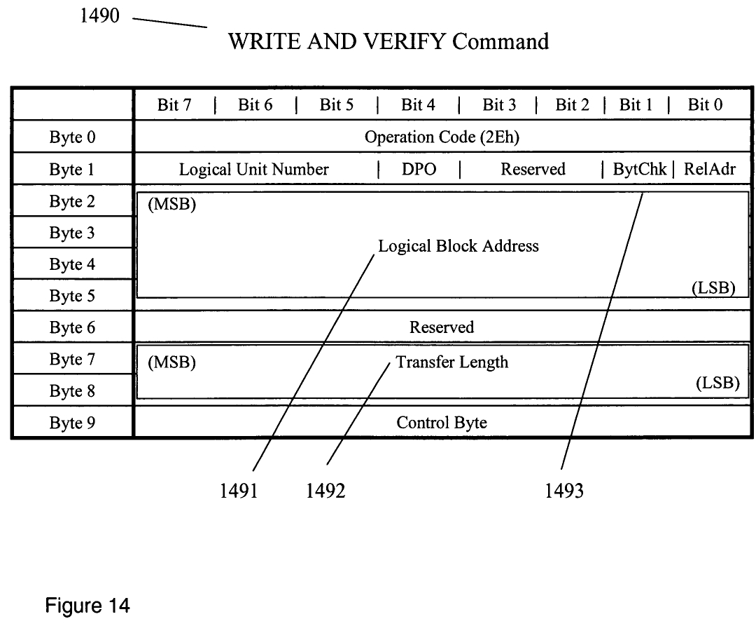

A query step 990 analyzes the WORM protection status of all CMD_LBAs from step 988. If the WORM protection status is set to WORM protected status 710 for any of the CMD_LBAs, the process ends at abend step 991 because the user is attempting to rewrite data in the WORM area of the storage medium. If the query step 990 finds no WORM protected status 710 for any of the CMD_LBAs, the process continues to a write data step 992 where the data in the CMD_LBAs is written to the disk drive. A query step 994 follows at which a determination is made whether the write process was successful or not. This determination may be made by performing a write verification or, alternatively, by reading the newly written data. The Write Verify command can be used in this step. This standard SCSI command performs a verification of the data which has been written. The Write Verify command is discussed hereinafter with reference to FIG. 14. If it is determined in step 994 that the write was not successful, the process flows to an error recovery step 996. If it is determined in step 994 that the write was successful, the process flows to a step 998 where the WORM protection status 895 given in the write command 890 is written to the sector headers 690. Step 998 implements the logic of FIG. 7 and only performs allowable transitions of the WORM protection status. After the WORM protection status is applied to the LBAs the process finishes at end step 999.

During the write operation of step 992, the storage device reads the sector information and verifies the WORM protection status. Only if the status indicates that the sector is rewritable is writing to the sector allowed. Because the sector header has to be read before the writing can start, two passes may be necessary. In the first pass the sector header information, in particular, the WORM protection status is read. In the second pass the data is written if allowed (step 992) and the WORM protection status is changed if necessary (step 998).

An exemplary Write Verify command 1490 is shown in FIG. 14. The LBA 1491 and transaction length 1492 are completely analogous to LBA 891 and transfer length 892 of Write Command 890 of FIG. 8. Byte Check (BytChk) 1493 has two values, either a zero or a one. The preferred value for Byte Check 1493 is one, whereby a byte-by-byte compare is made of the data written on the medium and the data transferred by the host. If the compare is unsuccessful for any reason, the disk drive returns a CHECK CONDITION STATUS with the sense key set to MISCOMPARE. It is this MISCOMPARE which is used to trigger the NO condition in step 994 of FIG. 9, and hence the subsequent error recovery. Steps 994 and 996 are optional. If steps 994 and 996 are desired, then the Write Verify command 1490 would be used in step 986. If steps 994 and 996 are deemed unnecessary, then the Write command 890 would be used in step 896.

It is preferred to have an extra memory 303 in the magnetic storage device for storing the WORM protection status for each LBA. The extra memory 303 is in addition to storage of the WORM protection status in the sector header or ECC of each LBA. The advantage of storing the WORM protection status in a fast access memory is that the status can be transferred to the host system on request without reading the actual sector headers resulting in significantly improved performance. The WORM protection status is also written to the reserved area of the storage device to ensure availability after a system power down.

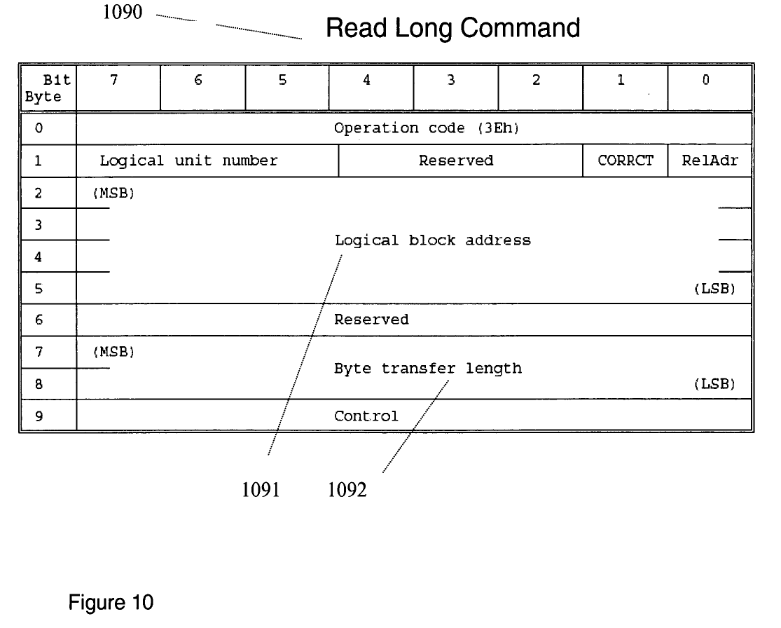

The WORM protection status for an LBA or a set of LBAs can be available to the operating system/device driver via a small computer system interface (SCSI) READ LONG command 1090 shown in FIG. 10. The data passed during the READ LONG command may vary for different vendors, but always includes the data bytes and the ECC bytes recorded on the medium. Thus, if the WORM protection status is included in the ECC, it can be detected with a READ LONG command. If the WORM bit is in the sector header, it can be detected via the drive microcode which is used to read the sector header. The starting LBA 1091 defines the first sector to be read and the transfer length 1092 defines how many sectors are to be read after the first sector. Therefore, sector data is returned for the LBA specified in 1091 and for the number of subsequent LBAs as specified in 1092.

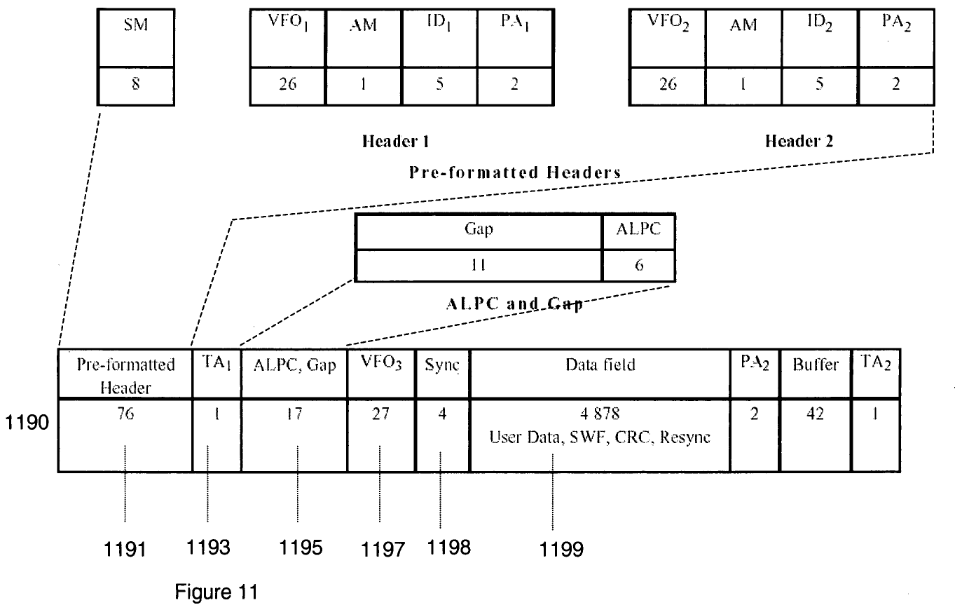

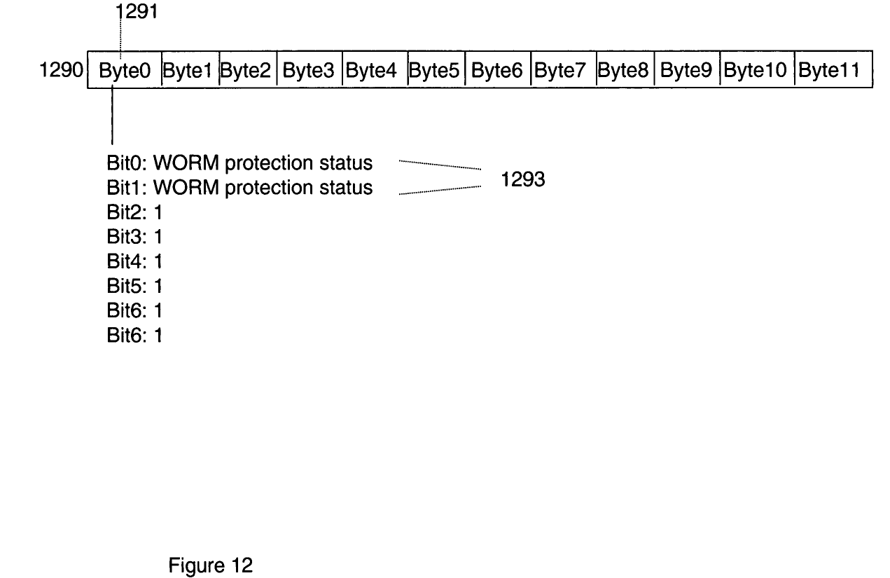

The layout of the sector format for a magneto optical disk cartridge is shown in FIG. 11. The format shown is for a 9.1 GB magneto optical disk cartridge according EMCA-322 standard. ECMA is the European Computer Manufacturers Association. The sector 1190 comprises a pre-formatted header 1191, a transition area 1193, a gap and laser power testing area 1195, synchronization areas 1197 and 1198, and data field 1199. The data field 1199 is the user data area comprising 4096 bytes. The WORM protection status information may be embedded in a part of the data field 1199, or more precisely in a string of 12 padded bytes after the Sector Written Flags (SWF). FIG. 12 shows the layout of the 12 padded bytes 1290. In the first byte 1291, bit0 and bit1 may be used to embed the WORM protection status 1293 as described herein above with respect to FIG. 7.

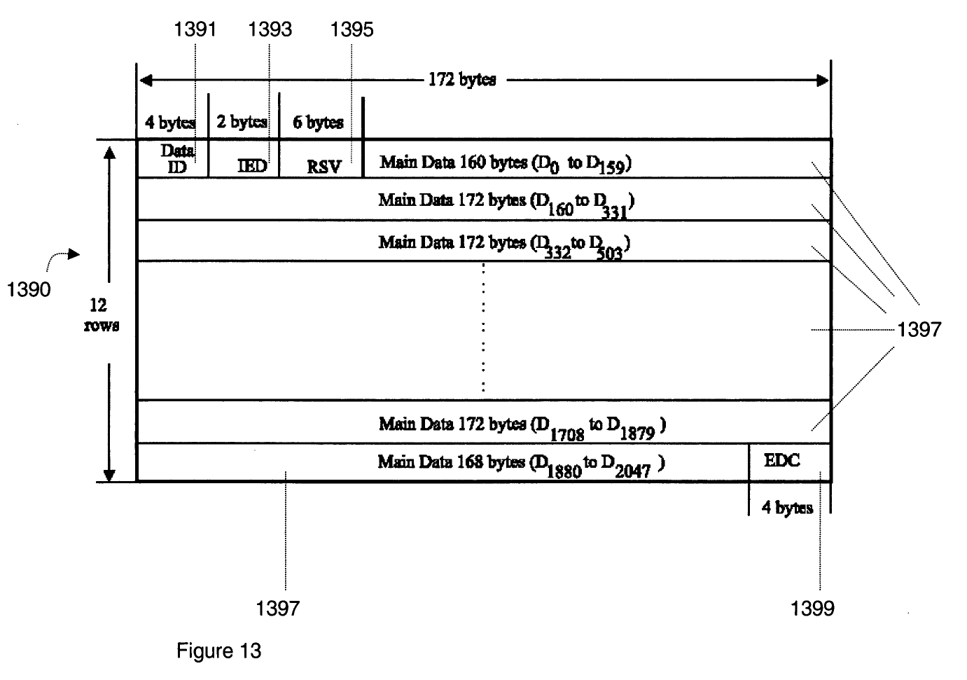

FIG. 13 shows the layout of the sector format 1390 for 120 mm and 80 mm DVD-Rewitable Disk (DVD-RAM) according to the ECMA-330 standard. The sector format 1390 comprises a data ID field 1301, a data ID error correction code field 1393, a reserved field 1395, and user data fields 1397 containing 2060 bytes of user data. A field 1399 at the end of the data fields 1397 contains an error detection code for the preceding user data. The WORM protection status may be embedded in the reserved field 1395 preceding the user data fields 1397. Of the 6 bytes in the reserved field 1395, we propose to use the first two bits of the first byte of this area to embed the WORM protection status as described herein above with reference to FIG. 7.

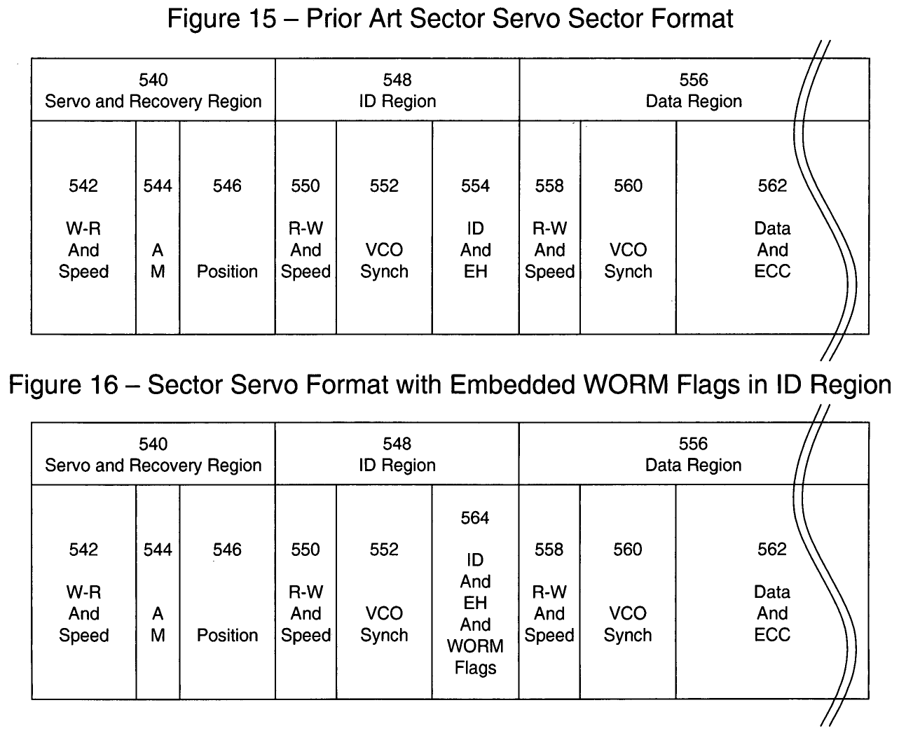

Various other embodiments to implement WORM protection status on a HDD are described with reference to FIGS. 15-34. Each embodiment involves the following steps:
1) Reading the WORM flag bits.
2) If writing to the sector is allowed based on the status of the WORM flags, then writing the data to the data field of the sector.
3) If the data field write is successful and the Command Descriptor Block indicates WORM write, then updating the WORM flags to reflect the WORM status of the sector. If the WORM flags are embedded in the data field, then the WORM flags are written on the same write pass as the data itself. If the WORM flags are embedded in the sector header, then the WORM flags are written on a separate write pass along with the rest of the sector header fields.

FIG. 15 shows a schematic view of a prior art Sector Servo Sector Format, used by many disk drive manufacturers prior to the date of 1995. The sector is divided into three regions with a Servo and Recovery Region 540, an ID Region 548, and a Data Region 556. The Servo and Recovery Region 540 comprises a Write-to-Read and Speed Adjustment field 542, an Address Mark 544, and a Position Field 546. The Write-to-Read and Speed Adjustment field 542 compensates for the delay associated with switching from a read mode to a write mode, and accommodates spindle speed variations. The Address Mark 544 is used for sensing radial position. The Servo Position Field 546 contains a position error signal for track alignment. The ID Region 548 comprises a Read-to-Write Recovery and Speed field 550, a VCO Synch field 552, and an Identification and Error Handling field 554. The Read-to-Write Recovery and Speed field 550 acts much the same as the Write-to-Read and Speed Adjustment field 542, but compensates for the delay of switching from write mode to read mode. The Voltage Controlled Oscillator (VCO) Sync field 552 is used to synchronize the read clock to the read data, in this case the ID and EH field 554. The Identification and Error Handling field 554 is used by the disk drive controller to identify the logical sector number and to store information used for error handling pertaining to whether or not the sector can be written and read successfully. The Data Region 556 comprises a Read-to-Write Recovery and Speed field 558, which is similar in function to the Read-to-Write Recovery and Speed field 550 contained in the ID Region 548, a VCO Synch field 560, which is similar in function to the VCO Synch field 552 found in the ID Region 548, and a Data and ECC field 562 which is where the actual data to be stored is written, along with associated ECC (Error Correction Code).

FIG. 16 shows the Sector Servo Sector format with embedded flags in the ID region 548, whereby the ID and EH field 554, shown in FIG. 15, has been expanded to include the flags for WORM designation and control as defined previously (564). The WORM flags may be located anywhere in 564, in our preferred embodiment they are last. In this embodiment, the WORM flags can be written and read at the same time as the ID and Error Handling 554 information is written or read. In order to perform a write command to a sector, the WORM Flags must be checked first, then the data written; then another pass is required to write the ID and Error Handling information as well as the WORM Flags.

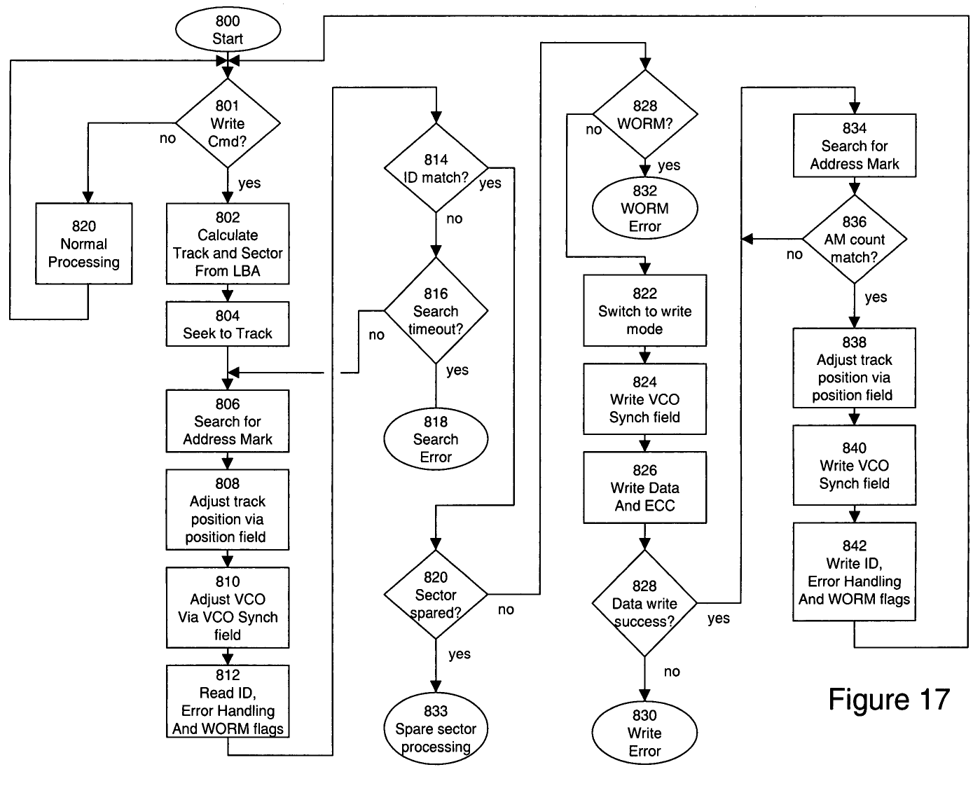

FIG. 17 shows the flow chart of how a write process is handled in the Sector Servo Sector format with embedded flags in the ID region from FIG. 16. The process starts at 800, where it flows to step 801, if the command is a not write command (no), then the command is handled as it would be normally (step 820). If the command is a write command (yes), then the process flows to step 802, where the disk processor calculates the track and sector based upon the LBA, then seeks to said track (step 804), then looks for an Address Mark 544 (step 806). The tracking is adjusted based on the position field 546 (step 808), then the Voltage Controlled Oscillator is adjusted via the VCO Synch field 552 (step 810), and then the ID, Error Handling, and WORM flags 564 are read in step 812. In step 814, if the ID in 564 does not match the sector to be written (no), then the process goes to step 816, where a check is made for a search timeout. If too much time has expired and the search has not completed (yes), then the process goes to step 818, where error handling takes effect due to a search timeout. If in step 816 there is not a search timeout (no), then the process flows back to step 806 to continue to search for the correct ID. If in step 814, the ID matches the sector to be written, then the process continues to step 820, where a check is made based upon the EH field in 564 as to whether the sector is usable or has been spared out. If the sector is spared out (yes), then the process flows to step 833, where the alternate sector is processed in a similar fashion to the primary sector. If in step 820 the sector is usable (no), then the process flows to step 828, where the WORM flags read in 564 are examined to determine whether the field is WORM protected. If the sector has already been written and marked as WORM protected (yes), then the process continues with a WORM error (832), and error handling takes effect. If in step 828 the sector is determined to be writable (no), then the process flows to step 822, where the R/W heads are switched to write mode, and then the VCO Synch field 560 is written (step 824), and the data and ECC 562 are written (step 826). At step 828, a check is made to determine if the write was successful. If not (no), then error handling code is invoked due to a write error (step 830). If the write is successful (yes), then the process flows to step 834, where a search is made for the address mark of the sector just written. A comparison is made such that if the number of address marks detected equals the number of sectors on the track (step 836). If the count of address marks is less than the number of sectors on the track (no), then the process returns to step 834 to find the next address mark. If the count matches (yes), then the process continues to step 838, where the tracking is adjusted via the position field 546, the VCO synch field 552 is written (step 840), and finally, the ID, error handling, and WORM flags 564 are written (step 842). The process then returns to step 801 to process the next command.

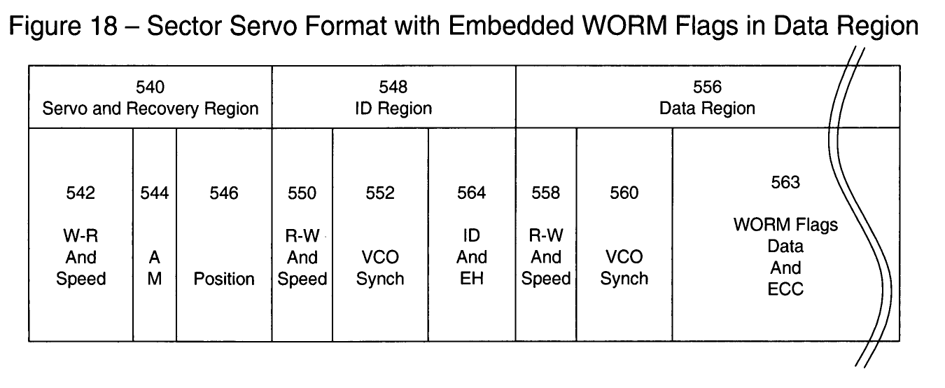

FIG. 18 shows the Sector Servo Sector format with embedded WORM flags in the Data region 556, whereby the Data and ECC field 562, shown in FIG. 15, has been expanded to include the flags for WORM designation and control as defined previously. In this embodiment, the WORM flags must be read before the data field is written, necessitating two passes at the sector to be written, one to read the WORM status, another to write the data and WORM flags. This allows the WORM status flags to be stored with the data, which consequently allows the WORM flags to be protected with the ECC along with the data, improving the WORM protection in the event of soft media errors in the WORM flag field. The WORM flags may be located anywhere in 563, in the preferred embodiment they are first.

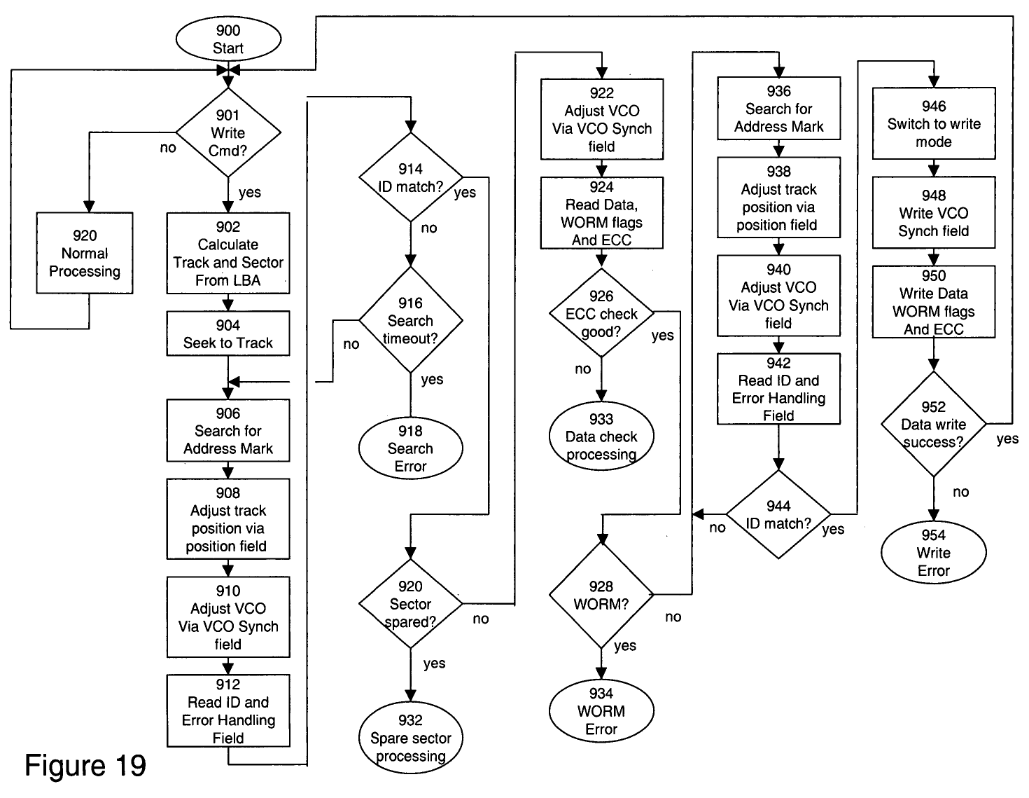

FIG. 19 shows a flow diagram of the process used to write a sector of the Sector Servo Sector format with embedded WORM flags in the Data region. The process begins at 900, where it flows to step 901, and a check is made to determine if the command is a write command. If the command is a not write command (no), then the command is handled normally (step 920). If the command is a write command (yes), then the process flows to step 902, where the track number and sector are calculated based upon the LBA. In step 904, the head assembly seeks to the appropriate track, then in step 906 a search is done for an address mark. When the address mark 906 is detected the process continues to step 908, where the track position is adjusted via the position field 546, the VCO is adjusted via the VCO Synch field 552 (step 910), and the ID and EH fields 564 are read (step 912). In step 914, a comparison is performed to determine if the ID field in 564 matches the sector to be written. If the sector ID does not match (no), then the process moves to step 916 to check for a search timeout. If too much time has expired during the search (yes), then error handling takes over due to a search error (step 918). If there has not been a timeout in step 916, then the process goes back to step 906 to continue to look for the proper sector ID. If in step 914 the sector ID matches the sector to be written (yes), then the process flows to step 920, where a check is made of the status of the sector. If it has been spared out (yes), then the process enters spare sector processing (step 932), where the spare sector is handled much the same as the primary sector would be. If the sector is good and has not been spared out (no), then the process goes to step 922, where the VCO is adjusted via the VCO Synch field 560, and the data, WORM flags, and ECC 563 are read (step 924). In step 926, the ECC check is done, and if the data and WORM flag bits in 563 are not readable then the process enters data check processing (step 933). If the data and WORM flag bits in 563 are readable, then the process continues to step 934, where the WORM flags are checked for WORM protection. If the sector is currently WORM protected (yes), then the write is aborted and error handling is invoked (step 934). If the sector is not WORM protected (no), then the process continues to step 936, where the next address mark is searched for. Because there are multiple sectors per track, the disk must rotate nearly once before the sector that has been written is located again, and several address marks will be detected. In step 938, the track position is adjusted, in step 940 the VCO is adjusted, and in step 944, the sector ID and error handling fields 564 are read. In step 944, the check is made to determine if the correct sector has been located. If the sector ID does not match the sector that was written (no), then the process returns to step 936 to search for the next address mark. If the sector ID does match the sector that was written (yes), then the process goes to step 946, where the head assembly switches to write mode, then the VCO synch field 560 is written (948), and the data, WORM flags, and ECC 563 are written. In step 952, a check is made for success. If the write has been successful (yes), then the process returns to step 901 to handle the next command. If the write was unsuccessful (no), then error handling code is invoked (step 954).

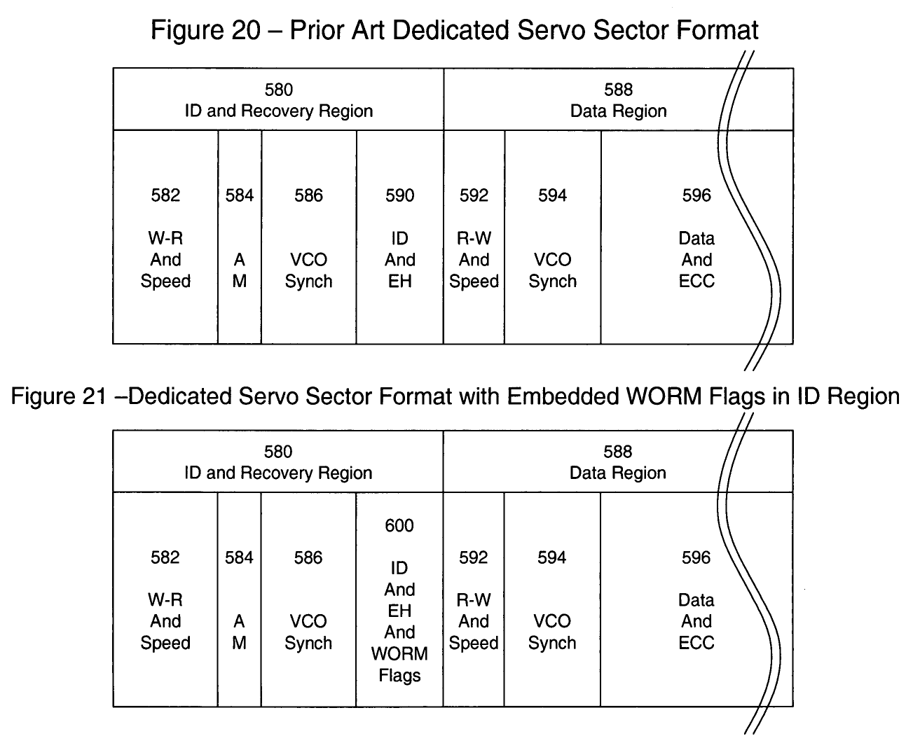

FIG. 20 shows a schematic view of a prior art Dedicated Servo Sector format. In this format, the servo information is written on a dedicated track, so some of the associated servo information that was necessary in the Sector Servo Sector format is eliminated in the Dedicated Servo Sector format from within the data sector. The Dedicated Servo Sector format is divided into two regions, the ID and Recovery region 580, and the Data region 588. The ID and Recovery region 580 contains fields that are similar to those found in the Servo and Recovery region 540 and ID region 548 found in FIG. 15 in the Sector Servo Sector format. The fields pertaining to servo function have been removed, as they are contained on a separate surface. The Write-to-Read and Speed field 582, the Address Mark 584, the VCO Synch field 586, and the ID EH field 590 are substantially the same in function to their counterparts in the Sector Servo Sector format shown in FIG. 15. Only one Read-to-Write and Speed field 592 is needed because Address Mark 584 can be written at the same time that the VCO Synch field 586 and the ID and EH field 590 are written. The Data Region 588 contains substantially the same information as the Data Region 556 in the Sector Servo Sector format shown in FIG. 15.

FIG. 21 illustrates the Dedicated Servo Sector format with the previously defined WORM flags embedded in the ID and Recovery region 580. In this embodiment, the WORM flags are written and read at the same time as the ID and EH field 590, shown in FIG. 20, so that the new field, the ID and EH and WORM Flags field 600 (FIG. 21) contains all three sets of information, the sector ID, the error step of the sector, and the WORM status. All other fields are substantially unchanged. In order to perform a write command to a sector, the WORM Flags must be checked first, then the data written, then another pass is required to write the Address Mark 584, the VCO Synch field 586 and the ID and EH field 590, as well as the WORM Flags. The WORM flags may be located anywhere in 600, in the preferred embodiment they are last.

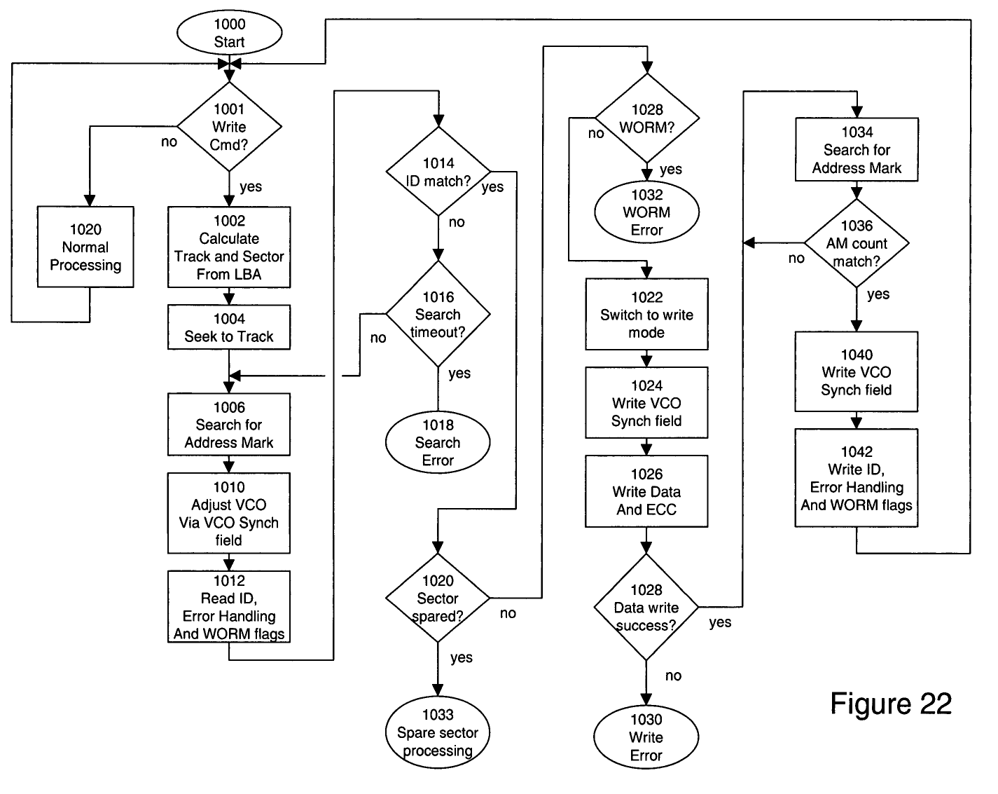

FIG. 22 shows a flow chart of the process of handling a command in a Dedicated Servo Sector format with the WORM flags embedded in the ID and Recovery region. The process begins at step 1000. At step 1001, a check is made as to the type of command. If the command is not a write command (no), then the process flows to step 1020, where the command is processed normally. If the command is a write (yes), then the process continues to step 1002, where the track number and sector are calculated based on the LBA. In step 1004, the head assembly seeks to the proper track; then a search is made for an address mark (step 1006). The VCO rate is adjusted via the VCO synch field 586 (step 1010), and the ID, error handling, and WORM flags 600 are read (step 1012). The process then flows to step 1014, where a check is made to see whether the ID read matches the sector to be updated. If the sector ID does not match (no), then the process flows to step 1016, where a check for a search timeout is done. If the search has exceeded the allotted time (yes), then the process goes to step 1018, where the search timeout is handled by error recovery code. the search has not timed out (no), then the process returns to step 1006 to look for the next address mark. If at step 1014 the sector ID matches that of the sector to be written (yes), then the process moves to step 1020, where the error handling field in 600 is checked to see whether the sector is usable, or whether it has been spared. If the sector has been spared (yes), then the process moves to step 1033, where the alternate sector is processed similar to a primary sector. If the sector has not been spared (no), then the process moves on to step 1028, where the WORM flags are checked. If the sector is WORM protected (yes), then the write is aborted with a WORM error (step 1032). If the sector is not WORM protected (no), then the process continues to step 1022, where the read/write electronics switch to write mode. The VCO synch field 594 is written (step 1024), and the data and ECC 596 are written as well (step 1026). At step 1028, if the write is not successful (no), the process moves to step 1030, where error handling is invoked to process the write error. If the write is successful (yes), then the process goes to step 1034, where a search for the address mark of the sector that was updated is performed. By counting address marks, the disk processor can ascertain when the address mark of the written sector has been located; hence, in step 1036 the count of address marks detected is compared to the number of sectors on the track to determine whether the current address mark is in the sector that was written. If it is not the correct sector (no) then the process returns to step 1034 to find the next address mark. If the count of address marks matches the number of sectors on the track (yes), then the process goes to step 1040, where the VCO synch field 586 is written. The ID field, error handling field, and WORM flags 600 are then written (step 1042), and the process returns to step 1001 to process the next command.

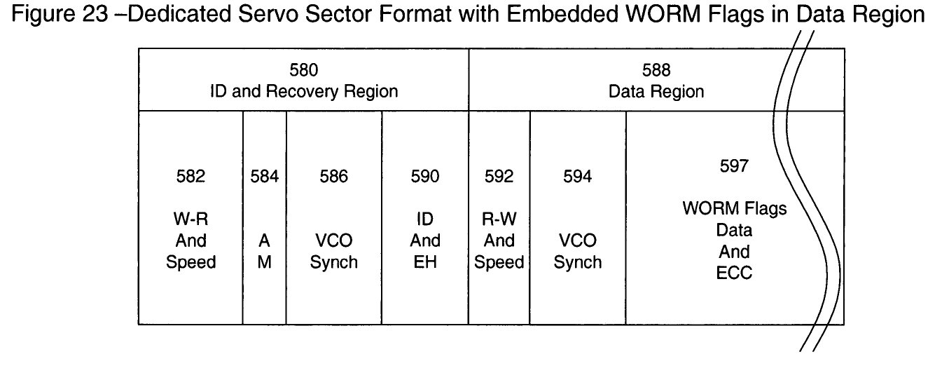

FIG. 23 illustrates the Dedicated Servo Sector format with the previously defined WORM flags embedded in the Data region 588. In this embodiment, the Data and ECC field 596, shown in FIG. 20, has been expanded to include the flags for WORM designation and control as defined previously necessitating two passes at the sector to be written, one to read the WORM status in 597, another to write the data and the WORM flags in 597. The WORM Flags may be modified, depending on the whether the associated write command indicated that the data was to be written as WORM. This allows the WORM status flags to be stored with the data, which consequently allows the WORM flags to be protected with the ECC along with the data, improving the WORM protection in the event of soft media errors in the WORM flag field. The WORM flags may be located anywhere in 597, in the preferred embodiment they are first.

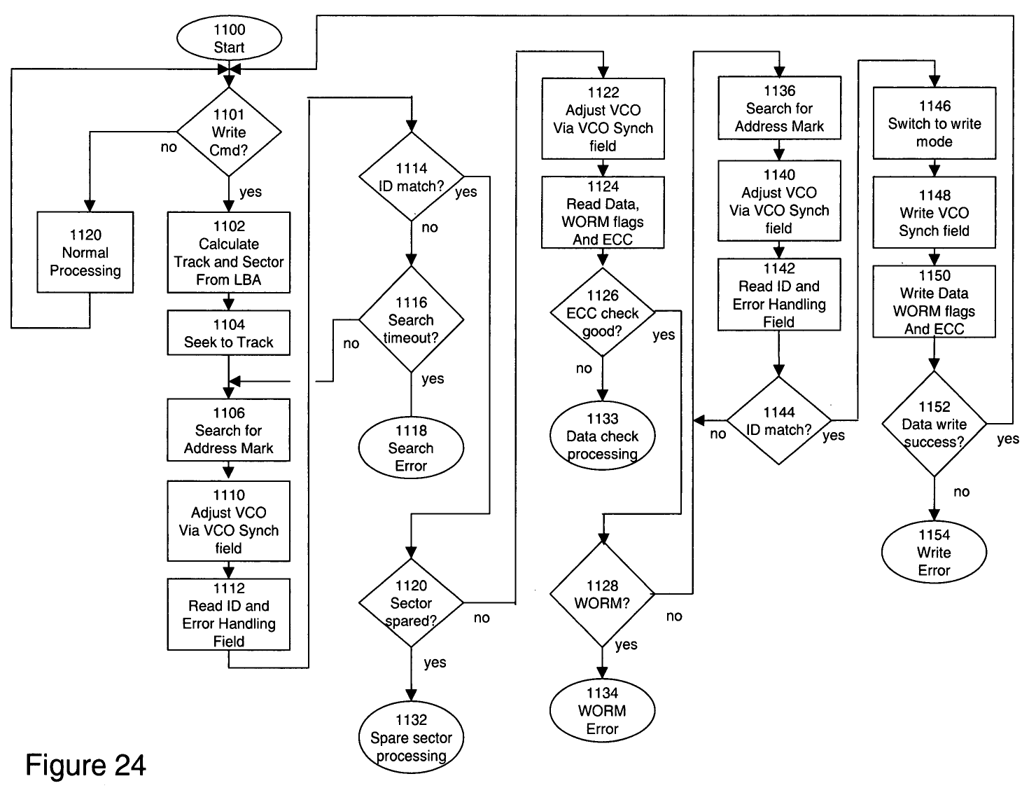

FIG. 24 shows the process of handling a command with the Dedicated Servo Sector format with the WORM flags embedded in the Data region. The process starts at step 1100, and proceeds to step 1101, where the command type is checked. If the command is not a write command (no), then it is handled normally (step 1120). If the command is a write command (yes), then the process flows to step 1102, where the track and sector are calculated based on the requested LBA. The actuator seeks to the track (step 1104), and then the process looks for an address mark 584 (step 1106). At step 1110, the VCO is adjusted via the VCO synch field 586, and at step 1112, the ID and error handling fields 590 are read. The process then moves to step 1114, where the ID from 590 in FIG. 23 is checked against the sector to be written. If the sector ID does not match the sector to be written (no), then the process checks for a search timeout condition (step 1116). If a timeout has occurred (yes), then error processing begins at step 1118 due to a search error. If there is not a search timeout (no), then the process returns to step 1106 to find the next sector. If at step 1114 the sector ID from 590 matches the sector to be written (yes), then the process continues to step 1120, where a check is made to determine if the sector is usable, or if it has been spared. If the sector has been spared (yes), then spare sector processing is invoked, and the alternate sector is processed in much the same manner as the primary sector. If at step 1120 the sector is not spared (no), then the process moves on to step 1122, where the VOC is adjusted via the VCO synch field 594. The data, WORM flags, and ECC 597 are then read in step 1124. If in step 1126 the ECC check indicates the data or flags are corrupted (no), then data check processing is invoked (step 1133). If the ECC check is successful (yes), then the process continues to step 1128, where the WORM flags are examined. If the sector is already WORM protected (yes), then the write is terminated with a WORM error (1134). If the sector is not already WORM protected (no), then process flows to step 1136, where the next address mark is located. The VCO is then adjusted via the VCO synch field 586 (step 1140), and the ID and error handling fields 590 are read (step 1142). The sector ID read from 590 is then compared to the sector that is to be written in step 1144. If they do not match (no), then the process returns to step 1136 to find the next address mark. If the sector ID read matches the sector to be written (yes), then the process moves to step 1146, where the head electronics switch to write mode. At step 1148 the VCO synch field 594 is written, then in step 1150, the data, WORM flags, and ECC 597 are written. Status check is performed at step 1152. If the write was not successful (no), error handling code is invoked at step 1154. If the write was successful (yes), then the process returns to step 1101 to process the next command.

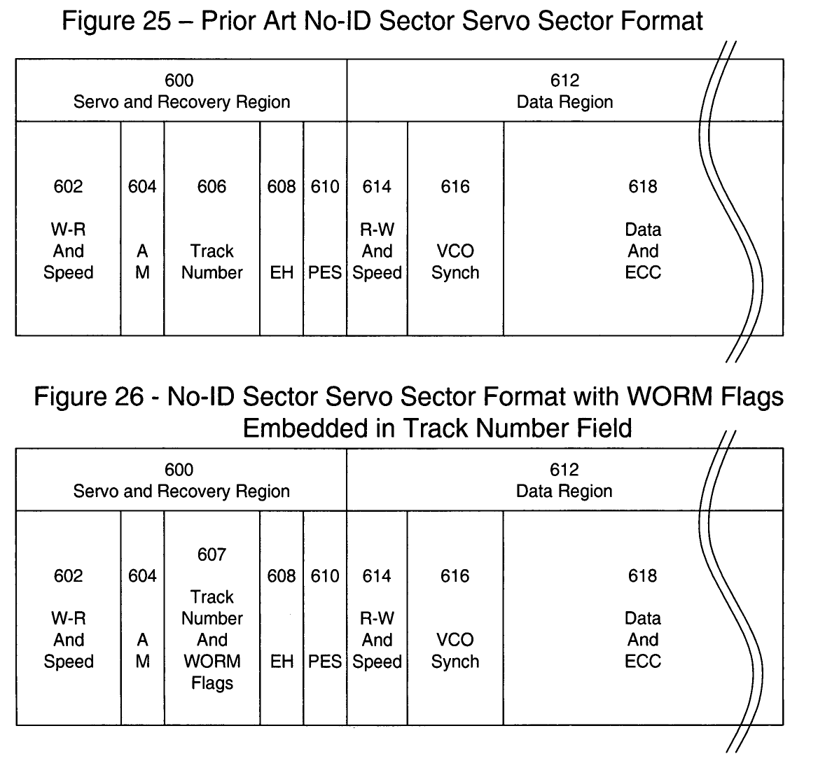

FIG. 25 shows a schematic view of prior art No-ID Sector Servo Sector format. This format is similar to the Sector Servo Sector format (FIG. 15), except that the Position field 546 (FIG. 15) has been expanded to include the Track Number 606 and the Error Handling 608 and Position Error Signal 610, the latter two having substantially the same function as the corresponding fields in the Sector Servo Sector format (FIG. 15). The Track Number 606 contains the track number on which the sector is located. The ID field has been eliminated. The Error Handling field 608 contains information used to determine whether the Track Number 606 has been read successfully. The Data Region 612 is substantially unchanged from the Sector Servo Sector format (FIG. 15).

FIG. 26 shows a schematic view of the No-ID Sector Servo Sector format with the previously defined WORM flags embedded in the Servo and Recovery region 600. In this embodiment, the WORM flags are written and read at the same time as the Track Number field 606, shown in FIG. 25, such that the new Track Number and WORM Flags field 607 (FIG. 26) contains both the track number on which the sector is located and the WORM status. All other fields are substantially unchanged. The WORM flags may be located anywhere in 607, in the preferred embodiment they are last.

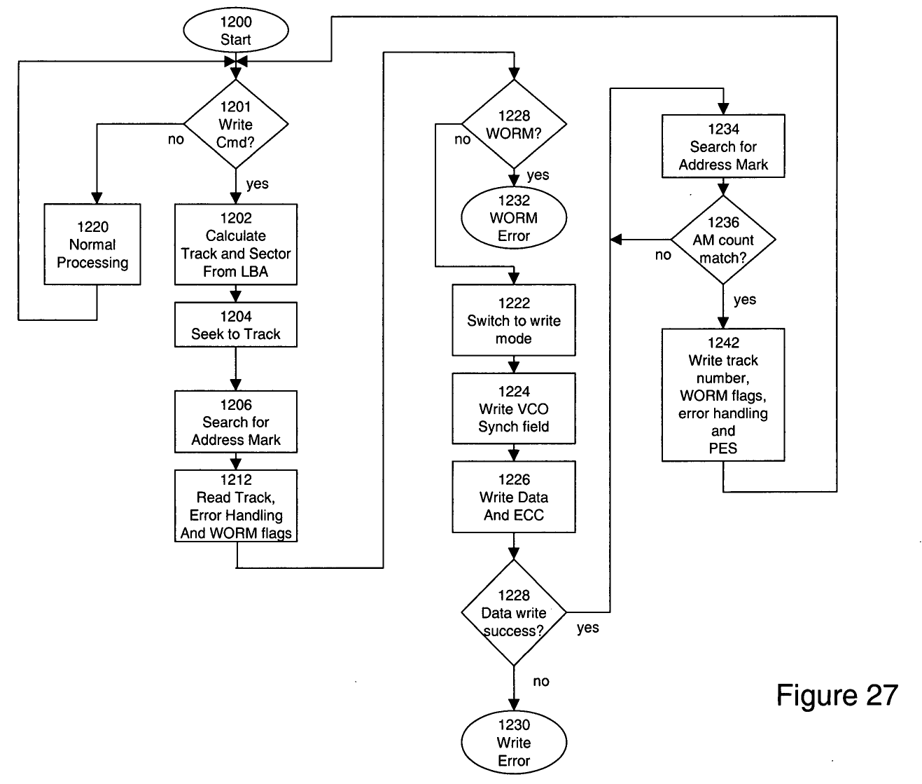

FIG. 27 shows a flow diagram of the processing of commands with the No-ID Sector Servo Sector format with the WORM flags embedded in the Servo and Recovery region. The process begins at step 1200, and flows to step 1201, where the command type is determined. If the command is not a write command (no), then the process flows to step 1220, and the command is processed normally. If the command is a write command (yes), then the process moves to step 1202, where the track and sector number are calculated based on the LBA. The actuator then seeks to the appropriate track (step 1204). Each track has a track header mark, so the head assembly can detect when the beginning of the track is located. By then counting the address marks, the disk processor can determine which sector each address mark is located in. In step 1204, the correct address mark 604 is located, then in step 1212, the track number, error handling information, and WORM flags 607 are read. In step 1228 the WORM status is determined by examining the WORM flags. If the sector is already WORM protected (yes), then the write is aborted with a WORM error (step 1232). If the sector is not WORM protected (no), then the process continues to step 1222, where the R/W electronics switch to write mode. In step 1224, the VCO synch field 616 is written, then in step 1226, the data and ECC 618 are written. In step 1228, if the write was not successful (no), then error handling is invoked (step 1230). If the write was successful (yes), then the process moves to step 1234, where the next address mark 604 is located. In step 1242, the address mark count is compared to the number of sectors on the track. If the number of address marks 604 detected since the last write is not equal to the number of sectors on the track (no), then the process returns to step 1234 to find the next sector address mark 604. If the number of address marks detected since the last write is equal to the number of sectors on the track (yes), then the sector that was written previously has been relocated, and the process moves to step 1242, where the track number and WORM flags 607, error handling 608, and PES 610 fields are written. The process then returns to step 1201 to handle the next command.

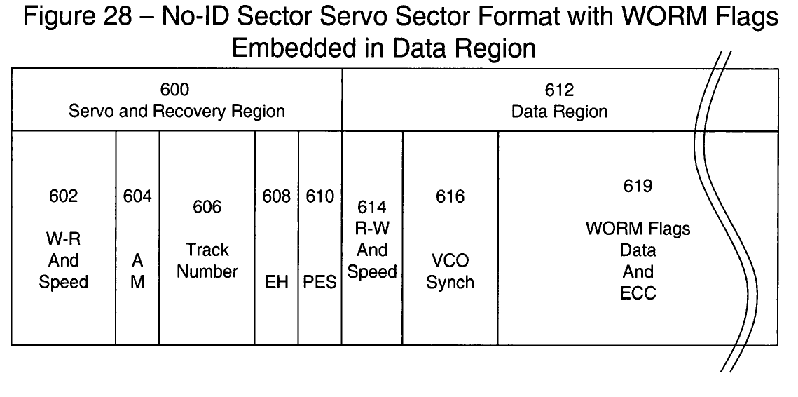

FIG. 28 shows a schematic view of the No-ID Sector Servo Sector format with the previously defined WORM flags embedded in the Data region 619. In this embodiment, the Data and ECC field 618, shown in FIG. 25, has been expanded to include the flags for WORM designation and control as defined previously (619). The WORM flags must be read before the data field is written, necessitating two passes at the sector to be written, one to read the WORM status, another to write the data and the WORM flags. The WORM Flags may be modified, depending on the whether the associated write command indicated that the data was to be written as WORM. This allows the WORM status flags to be stored with the data, which consequently allows the WORM flags to be protected with the ECC along with the data, improving the WORM protection in the event of soft media errors in the WORM flag field. All other fields are substantially unchanged from the No-ID Sector Servo Sector format (FIG. 25). This format is closest to the format most widely used in today's art, meaning it requires the least change to implement. The WORM flags may be located anywhere in 619, in the preferred embodiment they are first.

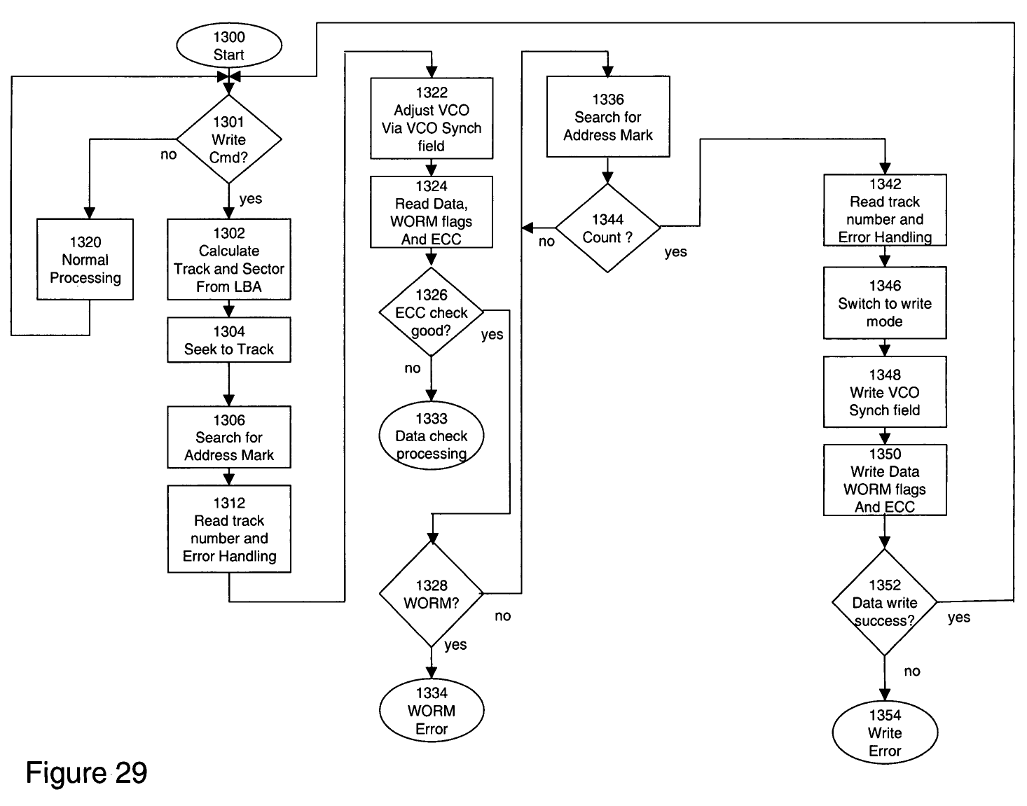

FIG. 29 diagrams the processing of commands for the No-ID Sector Servo Sector format with the WORM flags embedded in the Data region. The process begins at 1300, and flows to 1301, where the command type is determined. If the command is not a write command (no), then the process flows to step 1320, and the command is processed normally. If the command is a write (yes), then the process flows to step 1302, where the track number and sector are calculated from the LBA. In step 1304, the actuator seeks to the appropriate track, and in step 1306, the R/W assembly looks for the correct address mark. By sensing the track header mark, then counting the address marks, the proper sector is located. Once the correct sector address mark is located, the track number 606 and error handling field 608 are read (step 1312), and then the VCO is synched with the VCO synch field 616 (step 1322). The process then moves to step 1324, where the data, WORM flags, and ECC 619 are read. If the ECC check (step 1326) is unsuccessful (no), then the process invokes data check processing error recovery (step 1333). Otherwise, if the ECC check is successful (yes), then the process moves to step 1328, where the WORM flags from 619 are checked. If the sector is marked as WORM protected (yes), the write terminates with a WORM error (step 1334). Otherwise, the process continues to step 1336, where the next address mark 604 is located. Again, the sector is located by counting the number of sector address marks 604, so when the number of sector address marks 604 detected is equal to the number of sectors on the track, then the sector to be written has been relocated; so, if in step 1334, the count is not equal to the number of track sectors (no), then the process returns to step 1336, and the next address mark 604 is located. If in step 1334, the count equals the number of track sectors, then the process moves on to step 1342, where the track number 606 and error handling field 608 are read. In step 1346, the R/W electronics switch from read to write mode, then the VCO synch field 616 is written (step 1348), and the data, WORM flags, and ECC 619 are written (step 1350). The process flows to step 1352, where the status of the write is checked. If the write was not successful (no), then the process moves to step 1354, and error handling is invoked to handle the write error. If the write is successful (yes), then the process returns to step 1301 to handle the next command.

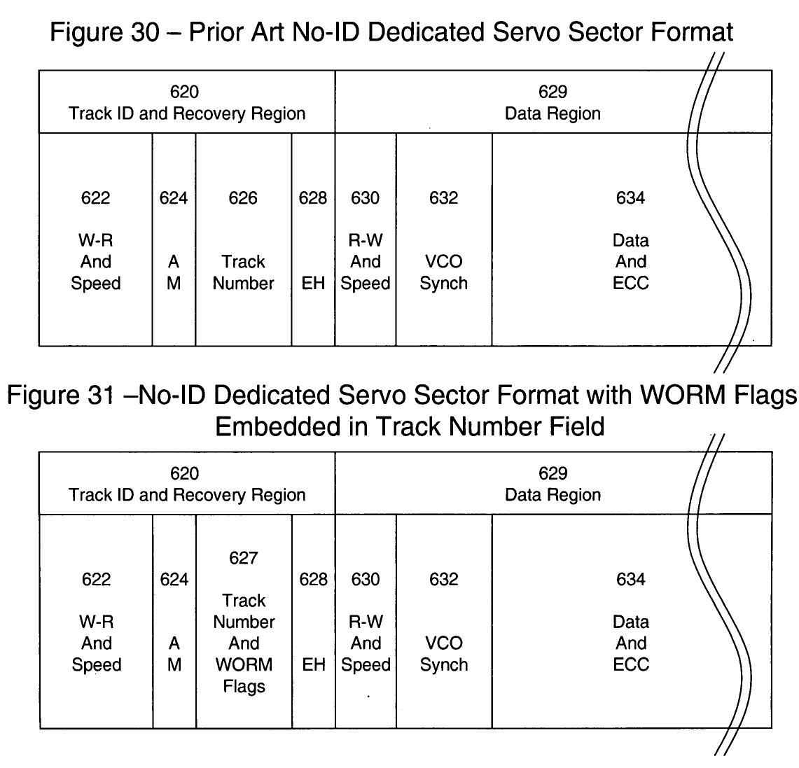

FIG. 30 shows a schematic view of prior art No-ID Dedicated Servo Sector format. This format is similar to the No-ID Sector Servo Sector format (FIG. 25), except that the servo information is stored on a separate surface from the rest of the data, so that the Position Error Signal 610 has been eliminated. All other fields are substantially unchanged.

FIG. 31 shows a schematic view of the No-ID Dedicated Servo Sector format with the previously defined WORM flags embedded in the Track ID and Recovery region 620. In this embodiment, the WORM flags are written and read at the same time as the Track Number field 626, shown in FIG. 30, such that the new Track Number and WORM Flags field 627 (FIG. 31) contains both the track number on which the sector is located and the WORM status. All other fields are substantially unchanged. In this embodiment, the WORM flags are written and read at the same time as the Address Mark 604, the Track Number (contained in 627), and the Error Handling field 628. The Error Handling Field 628 may include information to determine whether or not the WORM Flags have been read successfully. This means that in order to perform a write command to a sector, the WORM Flags must be checked first, then the data written, then another pass is required to write the Address Mark 624, the Track Number (contained in 627), and the Error Handling 628, as well as the WORM Flags. The WORM flags may be located anywhere in 627, in the preferred embodiment they are first.

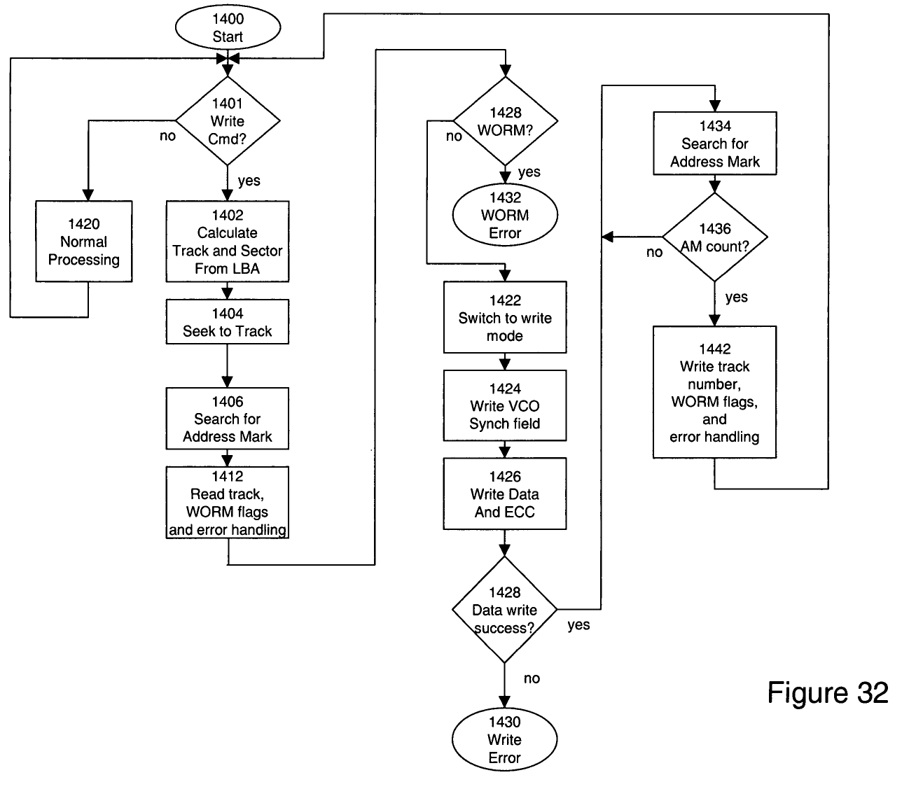

FIG. 32 details the process flow for command processing to a disk with the No-ID Dedicated Servo Sector format with the WORM flags embedded in the Track ID and Recovery region. The process starts at step 1400, and flows to step 1401, where the check is made as to whether the command is a write command. If the command is not a write command (no), then the process flows to step 1420, where normal command processing is invoked. If the command is a write command, then the process flows to step 1402, where the track number and sector are calculated based on the LBA presented in the Command Descriptor Block. The command processor then goes to step 1404, where it seeks to the calculated track. The servo information is contained on a separate, dedicated track, so the sector is located based upon this information. In step 1406, the address mark 624 for the sector is located, then the track number and WORM flags 627, and error handling 628 information are read in step 1412. Then the process moves to step 1428, where the WORM flags are examined. If the sector is already WORM protected (yes), then the process flows to step 1432, where the write is aborted and error recovery actions are invoked. If the sector is not already WORM protected, then the process moves to step 1422, where the R/W electronics switch from read to write mode. The VCO synch field 632 is then written (step 1424), then the data and ECC 634 are written (step 1426). The process then goes to step 1428, where the status of the write is determined. If the write was not a success, then error recovery is invoked (step 1430). If the write was successful, then the process flows to step 1434, where the next address mark 624 is located. In step 1436, the number of sector address marks 624 detected is compared to the number of sectors on the track. If they are not equal (no), then the process flows back to step 1434, and the next address mark 624 is located. If the number of sector address marks 624 detected is equal to the number of sectors on the track (yes), then the process flows to step 1442, where the track number and WORM flags 627, and error handling field 628 are written. The process then returns to step 1401 to process the next command.

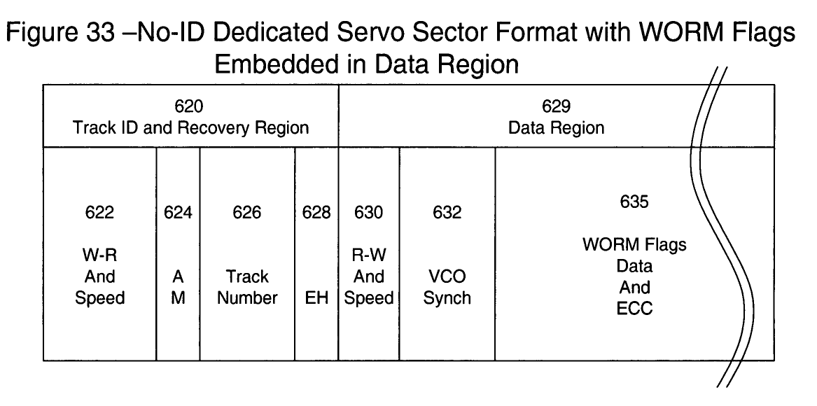

FIG. 33 shows a schematic view of the No-ID Dedicated Servo Sector format with the previously defined WORM flags embedded in the Data region 629. In this embodiment, the Data and ECC field 634, shown in FIG. 30, has been expanded to include the flags for WORM designation and control as defined previously (635). The flags must be read before the data field is written, necessitating two passes at the sector to be written, one to read the WORM status, another to write the data. This allows the WORM status flags to be stored with the data, which consequently allows the WORM flags to be protected with the ECC along with the data, improving the WORM protection in the event of soft media errors in the WORM flag field. All other fields are substantially unchanged from the No-ID Dedicated Servo Sector format (FIG. 30). The WORM flags may be located anywhere in 635, in the preferred embodiment they are first.

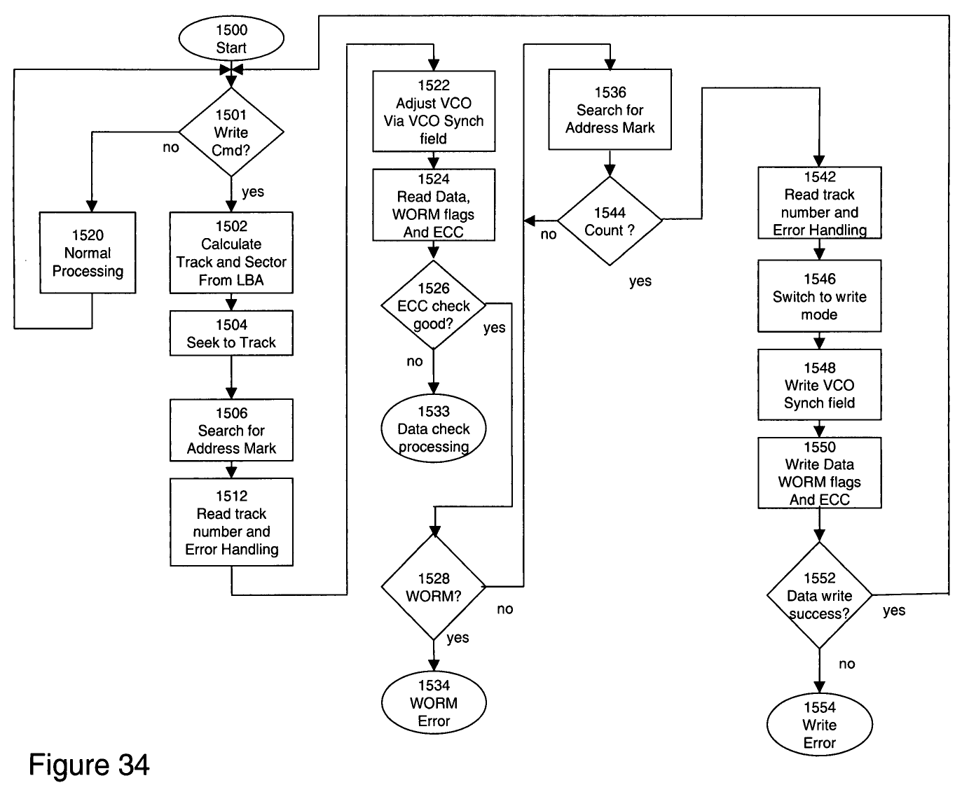

FIG. 34 charts the flow of the command processing for a disk with the No-ID Dedicated Servo Sector format with the WORM flags embedded in the Data region. The process begins at step 1500 and flows to step 1501, where the process determines whether or not the command is a write command. If the command is not a write command (no), then processing continues normally at step 1520. If the command is a write command (yes), then the process moves to step 1502, where the track number and track sector are calculated from the LBA extracted from the command descriptor block. The processor then seeks to the calculated track (step 1504). The sector is located via information stored on a separate, dedicated servo track. In step 1506, the address mark 624 for the calculated track sector is detected, then track number 626 and error handling information 628 are read (step 1512). In step 1522, the VCO is adjusted to synch with the VCO synch field 632, then the data, WORM flags, and ECC 635 are read in step 1524. The process then flows to step 1526, where the ECC check is performed. If the ECC check fails, and the data or WORM flags can not be reconstructed (no), then the process invokes error handling for data checks (step 1533). If the ECC verifies successfully (yes), then the process moves to step 1528, where the WORM flags are examined. If the sector is WORM protected (yes), then the write is terminated as a WORM error (step 1534). If the sector is not WORM protected (no), then the process moves to step 1536, where the next sector address mark 624 is located. The sectors are tallied in step 1544, and the count is compared to the number of sectors on the track. If the count of sector address marks 624 is not equal to the number of sectors on the track, then the process returns to step 1536 to find the next sector address mark 624. If the count of sector address marks is equal to the number of sectors on the track, then the process moves on to step 1542, where the track number 626 and error handling information 628 are read. In step 1546, the R/W assembly switches from read to write mode. The VCO Synch field 632 is then written (step 1548), then the data, WORM flags, and ECC 635 are written in step 1550. The status of the write is checked in step 1552. If the write was not successful (no), then error handling is invoked due to a write error (step 1554). Otherwise, if the write was successful (yes), then the process flows to step 1501 to process.

While the present invention has been particularly shown and described with reference to the preferred embodiments, it will be understood by those skilled in the art that various changes in form and detail may be made without departing from the spirit, scope and teaching of the invention. Accordingly, the disclosed invention is to be considered merely as illustrative and limited only as specified in the appended claims.

We claim:

1. A method for implementing a sector selectable write-once read-many (WORM) functionality on a disk drive storage system containing at least one rotatably mounted disk for recording data on at least one surface of said at least one rotatably mounted disk and a movable actuator supporting at least one transducer head, said actuator positioning said at least one transducer head to access data on said at least one surface of said at least one rotatably mounted disk, and a memory, said method comprising:
receiving a write command;
obtaining write command logical block addresses (LBAs) from the write command;
obtaining a WORM protection status for all the write command LBAs;
ending the write command if any of the write command LBAs is write protected;
writing the data to the disk drive system if none of the write command LBAs is write protected; and
writing the WORM protection status given in the write command to the write command LBAs.

2. The method recited in claim 1, wherein the WORM write protection status of the write command LBAs is obtained from the memory.

3. The method recited in claim 1, wherein the memory is FLASH memory

4. The method recited in claim 1, wherein the memory is a PROM.

5. The method recited in claim 1, wherein the memory is EPROM.

6. The method recited in claim 1, wherein the disk drive system is a magnetic disk drive system.

7. The method recited in claim 1, wherein the disk drive system is an optical disk drive system.

8. A method for implementing a sector selectable write-once read-many (WORM) functionality on a disk drive storage system containing at least one rotatably mounted disk for recording data on at least one surface of said at least one rotatably mounted disk and a movable actuator supporting at least one transducer head, said actuator positioning said at least one transducer head to access data on said at least one surface of said at least one rotatably mounted disk, and a memory, said method comprising:
receiving a write command;
reading a starting logical block address (LBA) and a transfer length from the write command;
obtaining a WORM protection status from the memory for each of the LBAs included in the write command;
ending the write command if any of the LBAs included in the write command is write protected;
writing the data to the disk drive system if none of the LBAs included in the write command is write protected; and
writing the WORM protection status given in the write command for each LBA included in the write command to each LBA.

9. A disk drive data storage device, comprising:
a disk drive base;
at least one rotatably mounted disk for recording data on at least one surface of said at least one rotatably mounted disk;
a movable actuator supporting at least one transducer head for recording data on at least one surface of said at least one rotatably mounted disk;
circuitry for controlling the operation of said disk drive data storage device, said circuitry producing at least one write signal that instructs said at least one transducer head to write data to at least one portion of at least one surface of at least one rotatably mounted disk; and
a memory containing a WORM status bit for each LBA in said disk drive data storage device, wherein said WORM status bit is set to one of at least two values, a first value that allows the LBA to be rewritable and a second value that prevents the LBA from being overwritten.

10. The disk drive data storage device recited in claim 9, wherein a WORM status bit for an LBA set to a value that prevents the LBA from being overwritten cannot be reset.

11. The disk drive data storage device recited in claim 9, wherein a WORM status bit for an LBA that is written is set to a value that prevents the LBA from being overwritten.

12. The disk drive data storage device recited in claim 9, wherein said memory is a FLASH memory.

13. The disk drive data storage device recited in claim 9, wherein said memory is a PROM.

14. The disk drive data storage device recited in claim 9, wherein said memory is an EPROM.

15. An article of manufacture comprising signal-bearing storage media including program logic embedded therein that causes control circuitry and memory of a disk drive data storage device to perform the steps of:
receiving a write command;
obtaining write command logical block addresses (LBAs) from the write command;
obtaining a WORM protection status for all the write command LBAs;
ending the write command if any of the write command LBAs is write protected;
writing the data to the disk drive data storage device if none of the write command LBAs is write protected; and
writing the WORM protection status given in the write command to the write command LBAs.

16. The article of manufacture recited in claim 15, wherein the WORM protection status for an LBA that is write protected cannot be reset.

17. The article of manufacture recited in claim 15, wherein the WORM write protection status of the write command LBAs is obtained from the memory.

18. The article of manufacture recited in claim 15, wherein the memory is FLASH memory

19. The article of manufacture recited in claim 15, wherein the memory is a PROM.

20. The article of manufacture recited in claim 15, wherein the memory is EPROM.

21. The article of manufacture recited in claim 15, wherein the disk drive data storage device is a magnetic disk drive system.

22. The article of manufacture recited in claim 15, wherein the disk drive data storage device is an optical disk drive system.

23. A method for implementing a sector selectable write-once read-many (WORM) functionality on a disk drive data storage system containing at least one rotatably mounted disk for recording data on at least one surface of said at least one rotatably mounted disk and a movable actuator supporting at least one transducer head, said actuator positioning said at least one transducer head to access data on said at least one surface of said at least one rotatably mounted disk, said method comprising:
receiving a write command to write data to the disk drive system;
obtaining a logical block address (LBA) and transfer length from the write command;
calculating a sector from the LBA;
reading a sector WORM protection status from a sector servo sector format of the sector;
ending the write command if the sector is write protected;
writing the data to the disk drive system if the sector is not write protected; and
writing a WORM protection status given in the write command to the sector servo sector format.

24. The method of claim 23, wherein the sector WORM protection status is embedded in the ID region of the sector servo sector format.

25. The method of claim 24, wherein the sector servo sector format is a dedicated sector servo sector format.

26. The method of claim 23, wherein the sector WORM protection status is embedded in the DATA region of the sector servo sector format.

27. The method of claim 26, wherein the sector servo sector format is a dedicated sector servo sector format.

28. The method of claim 26, wherein the sector servo sector format is a No-ID sector servo sector format.

29. The method of claim 26, wherein the sector servo sector format is a No-ID dedicated sector servo sector format.

30. The method of claim 23, wherein the WORM protection status is embedded in the TRACK NUMBER field of the sector servo sector format.

31. The method of claim 30, wherein the sector servo sector format is a No-ID sector servo sector format.

32. The method of claim 30, wherein the sector servo sector format is a No-ID dedicated sector servo sector format.
